(19) United States
(12) Patent Application Publication
(10) Pub. No.: US 2026/0014904 A1
(43) Pub. Date: Jan. 15, 2026

(54) MOTOR VEHICLE HAVING RECONFIGURABLE CABIN INTERIOR

(71) Applicant: Ford Global Technologies, LLC, Dearborn, MI (US)

(72) Inventors: Patrick Maloney, Livonia, MI (US); Kevin VanNieulande, Fraser, MI (US); Marcos Silva Kondrad, Macomb Township, MI (US); Kevin Wayne Preuss, Ortonville, MI (US)

(73) Assignee: Ford Global Technologies, LLC, Dearborn, MI (US)

(21) Appl. No.: 18/769,975

(22) Filed: Jul. 11, 2024

(51) Int. Cl. B60N 2/02; B60N 2/01; B60N 2/12; B60N 2/75; B62D 1/183

(52) U.S. Cl. CPC B60N 2/0233; B60N 2/01; B60N 2/0239; B60N 2/12; B60N 2/773; B62D 1/183

(57) ABSTRACT

A motor vehicle includes a passenger compartment, a steering wheel configured to be moveable between a use position and a stowed position, a floor, a seating rail system positioned on the floor and extending along a longitudinal direction of the motor vehicle, and a plurality of seating assemblies arranged in the passenger compartment in a first row, a second row, and a third row and configured to be actuated to a plurality of positions. Also included is a center console on a center console rail system extending longitudinally on the floor. A controller is configured to receive an input commanding a selected passenger compartment arrangement. The controller controls the actuators to position the seat assemblies, the center console and the steering wheel in the commanded passenger compartment arrangement.

### FIELD OF THE DISCLOSURE

The present disclosure generally relates to motor vehicles, and more particularly relates to a motor vehicle having an adjustable seating arrangement within the passenger compartment of the vehicle.

### BACKGROUND OF THE DISCLOSURE

The passenger vehicles commonly have a passenger compartment typically provided with a plurality of seating assemblies. The positioning of the plurality of seating assemblies within the passenger compartment can define a seating arrangement. Existing approaches of passenger compartment designs typically are limited to merely adjusting the overall seating capacity or forward and rearward or incline adjustments of the seating assemblies. It would be desirable to provide for an adjustable seating arrangement that offers more flexibility.

### SUMMARY OF THE DISCLOSURE

According to a first aspect of the present disclosure, a motor vehicle includes a passenger compartment, a steering wheel configured to be moveable between a use position and a stowed position, a floor, a seating rail system positioned on the floor and extending along a longitudinal direction of the motor vehicle, and a plurality of seating assemblies arranged in the passenger compartment in a first row and a second row located rearward of the first row. Each of the seating assemblies include a seat base coupled to the seating rail system, a seat movably coupled to the seat base, a seat back movably coupled to the seat base, and one or more seat actuators configured to actuate the seating assemblies to a plurality of positions. A controller is configured to receive an input commanding a selected passenger compartment arrangement. The controller controls the actuators to position the seat assemblies and the steering wheel in the commanded passenger compartment arrangement.

Embodiments of the first aspect of the present disclosure can include any one or a combination of the following features:
a center console rail system
a center console positioned on the center console rail system extending longitudinally on the floor;
a center console actuator to actuate the center console on the center console rail system, wherein the controller controls the actuators to position the center console in the commanded passenger compartment arrangement;
a user input device for inputting selection of the user input;
the user input device comprises one of a phone, a key fob, a microphone, a gesture detecting device, and a touchscreen display;
the selected seating arrangement includes one of a driving mode, a conference mode, and a relaxation mode;
the relaxation mode comprises one of a front facing rear relaxation mode and a rear facing relaxation mode;
the seating assemblies in the first row seating and the second row seating further comprise a swivel actuator for rotating the seats about a vertical axis;
the plurality of seating assemblies further comprise a third row located rearward of the second row.
the third row seating comprises a seat back adjacent to a rear wall of the passenger compartment;
the forward region includes the first row, the central region includes the second row, and the rearward region includes the third row in a driving mode;
the vehicle comprises a pickup truck; and
the pickup truck comprises three doors on each of the opposite lateral sides for accessing the three rows of seating.

According to a second aspect of the present disclosure, a motor vehicle is configured as a pickup truck. The motor vehicle includes a passenger compartment having a forward region, a central region, and a rearward region, a steering wheel configured to be moveable between a use position and a stowed position, a floor, a seating rail system positioned on the floor and extending along a longitudinal direction of the motor vehicle, and a plurality of seating assemblies arranged in the passenger compartment in a first row configurable in the forward region, a second row configurable in the middle region and located rearward of the first row, and a third row configurable in the rearward region located rearward of the second row. Each of the seating assemblies include a seat base coupled to the seating rail system, a seat movably coupled to the seat base, a seat back movably coupled to the seat base, and one or more seat actuators configured to actuate the seating assemblies to a plurality of positions. Also included are a center console rail system, a center console positioned on the center console rail system extending longitudinally on the floor, a center console actuator to actuate the center console on the center console rail system, and a controller configured to receive an input commanding a selected passenger compartment arrangement. The controller controls the actuators to position the seat assemblies, the center console and the steering wheel in the commanded passenger compartment arrangement.

Embodiments of the second aspect of the present disclosure can include any one or a combination of the following features:
a user input device for inputting selection of the user input;
the user input device comprises one of a phone, a key fob, a microphone, a gesture detecting device, and a touchscreen display;
the selected seating arrangement includes one of a driving mode, a conference mode, and a relaxation mode;
the relaxation mode comprises one of a front facing relaxation mode and a rear facing relaxation mode;
the seating assemblies in the first row seating and the second row seating further comprise a swivel actuator for rotating the seats about a vertical axis;
the third row seating comprises a seat back adjacent to a rear wall of the cab; and
the pickup truck comprises three doors on each of the opposite lateral sides for accessing the three rows of seating.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top schematic view of a motor vehicle having a passenger compartment with an adjustable seating and center console arrangement;

FIG. 1A is a perspective view of exemplary user input devices for selecting a passenger seating and center console compartment arrangement of the vehicle;

FIG. 2 is a side perspective view of the motor vehicle shown having an arrangement of seating assemblies and the center console in a driving mode;

FIG. 3 is a side perspective view of the motor vehicle shown having an arrangement of seating assemblies and the center console in an office mode;

FIG. 4 is a side perspective view of the motor vehicle shown having an arrangement of seating assemblies and the center console in a social mode;

FIG. 5 is a side perspective view of the motor vehicle shown having an arrangement of seating assemblies and the center console in a third row access mode;

FIG. 6 is a side perspective view of the motor vehicle shown having an arrangement of seating assemblies and the center console in a first cargo mode;

FIG. 7 is a side perspective view of the motor vehicle shown having an arrangement of seating assemblies and the center console in a second cargo mode;

FIG. 8 is a side perspective view of the motor vehicle shown having an arrangement of seating assemblies and the center console in a relaxed mode;

FIG. 9 is a side perspective view of the motor vehicle shown having an arrangement of seating assemblies and the center console in a child seat load mode;

FIG. 10 is a state diagram illustrating a plurality of selectable passenger seat and center console modes, according to one embodiment;

FIG. 11 is a block diagram illustrating a controller for receiving a user selectable passenger arrangement input command and controlling the seating, center console and steering wheel to reconfigure the cabin interior in the selected arrangement;

FIGS. 12A-12D are a flow diagram illustrating a routine for initiating a selectable arrangement of the passenger seating and center console;

FIGS. 13A-13D are a flow diagram illustrating a routine for transitioning the passenger compartment from the driving mode to the office mode, according to one example;

FIGS. 14A-14B are a flow diagram illustrating a routine for transitioning the passenger compartment from the driving mode to the social mode, according to one example;

FIG. 15 is a flow diagram illustrating a routine for transitioning the passenger compartment from the driving mode to the child load mode, according to one example;

FIG. 16 is a side perspective view of a motor vehicle, having an arrangement of seating assemblies and a center console shown in a social mode, according to another embodiment;

FIG. 17A is an upper side perspective view of a steer-by-wire steering wheel of the motor vehicle in FIG. 16 shown in a use position;

FIG. 17B is an upper perspective view of the steer-by-wire steering wheel shown in a partially stowed position;

FIG. 17C is an upper perspective view of the steer-by-wire steering wheel shown in a fully stowed position;

FIG. 18 is a side perspective view of the motor vehicle shown in FIG. 16 having the passenger compartment arranged in a relaxed mode;

FIG. 19 is a side perspective view of the motor vehicle shown in FIG. 16 having the passenger compartment arranged in a social mode;

FIG. 20 is a flow diagram illustrating a routine for inputting commands to reconfigure the passenger compartment;

FIG. 21 is a state diagram illustrating a plurality of selectable passenger compartment modes, according to the embodiment of FIG. 16;

FIGS. 22A-22B are a flow diagram illustrating a routine for transitioning the passenger compartment from the driving mode to a first and second row conference mode, according to the embodiment of FIG. 16;

FIGS. 23A-23B are a flow diagram illustrating a routine for transitioning the passenger compartment from the driving mode to a front facing relaxation mode, according to the embodiment of FIG. 16;

FIGS. 24A-24C are a flow diagram illustrating a routine for transitioning the passenger compartment from the driving mode to a rear facing relaxation mode, according to the embodiment of FIG. 16;

FIGS. 25A-25B are a flow diagram illustrating a routine for transitioning the passenger compartment from a conference mode to a front facing relaxation mode, according to the embodiment of FIG. 16;

FIGS. 26A-26C are a flow diagram illustrating a routine for transitioning the passenger compartment from the front facing relaxation mode to a rear facing relaxation mode, according to the embodiment of FIG. 16; and

FIGS. 27A-27B are a flow diagram illustrating a routine for transitioning the passenger compartment from the conference mode to a rear facing relaxation mode, according to the embodiment of FIG. 16.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

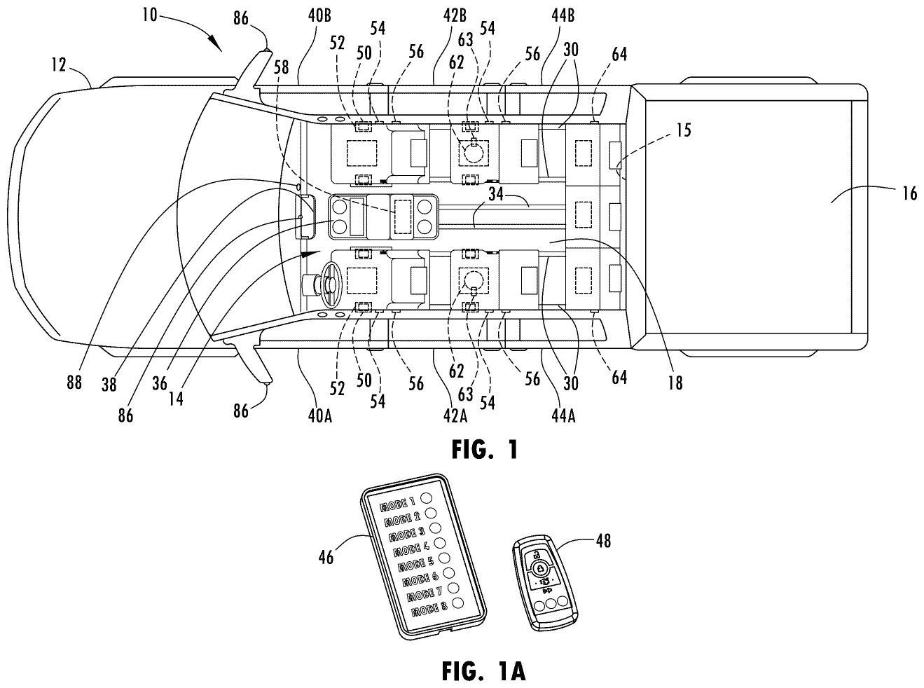

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle having user selectable seating and center console arrangements and a method of controlling the arrangements. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, a motor vehicle 10 is generally illustrated in the form of a pickup truck having a body 12, a cabin interior defining a passenger compartment 14 and a bed 16 at the rear end. The motor vehicle 10 shown and described herein is a pickup truck that includes in the passenger compartment 14 three rows of passenger seating 20, 22, and 24 positioned generally proximate to three rows of six doors 40A-40F with front first and second doors 40A and 40B on opposite sides of the first row of seating 20, middle third and fourth doors 42A and 42B located on opposite lateral sides of the second row of seating 22, and the rear fifth and sixth doors 44A and 44B located on opposite sides of the third row of seating 24. The passenger compartment has a forward region generally including the first row of seating, a central region generally including the second row of seating, and a rearward region generally including the third row of seating. As such, the motor vehicle 10 may seat passengers in three rows which may include two seats in the first row of seating 20, two seats in the second row of seating 22 and three seats in the third row of seating 24, according to the example shown.

The first and second doors 40A and 40B have hinges on the front end that allow the first and second doors 40A and 40B to pivot between open and closed positions. Similarly, the third and fourth doors 42A and 42B have hinges on the front end that allow the third and fourth doors 42A and 42B to pivot between open and closed positions. The first and sixth doors 44A and 44B are smaller doors that pivot about hinges on the rear end when the third and/or fourth doors 42A and 42B are in the open position to present an enlarged size door opening.

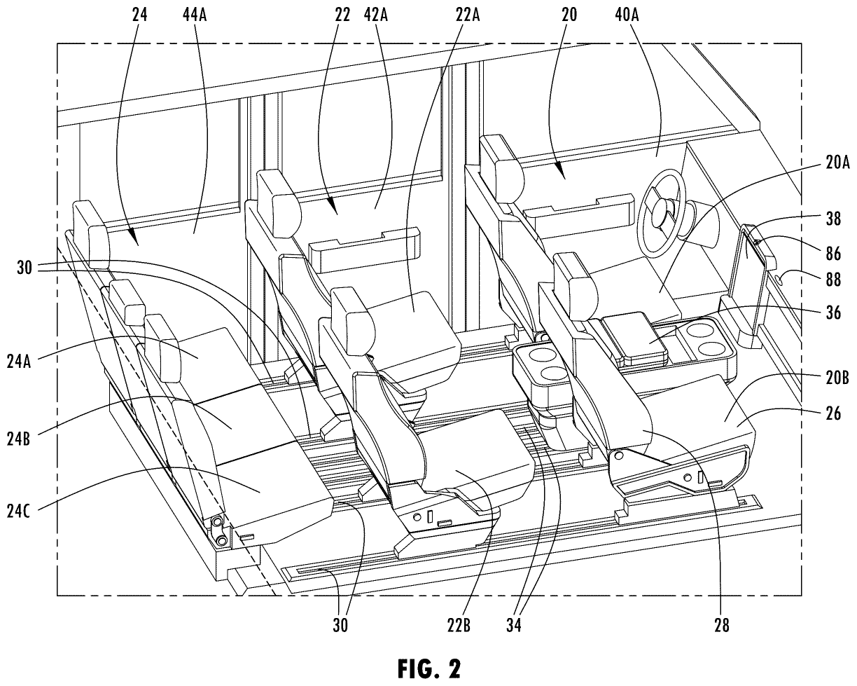

With reference to FIGS. 1 and 2, the passenger compartment 14 of the motor vehicle 10 is shown having a first seat assembly 20A and a second seat assembly 20B located in the first or front row of seating 20. The first seat assembly 20A may be a driver's seat which is generally located rearward of a steering wheel. Each of the seat assemblies 20A and 20B generally include a seat base 26 and a seat back 28 which may recline and incline relative to the seat base 26.

The second or middle row of seating 22 includes a third seat assembly 22A and a fourth seat assembly 22B. Each of the third and fourth seat assemblies 22A and 22B includes a seat base 26 and a seat back 28 which may rotate to incline or recline relative to the seat base 26. The second row of seating 22 is generally positioned vehicle rearward of the first row of seating.

The third or rear row of seating 24 includes a fifth seat assembly 24A, a sixth seat assembly 24B and a seventh seat assembly 24C. The sixth seat assembly 24B is generally located between the fifth and seventh seat assemblies 24A and 24C. The fifth, sixth and seventh seat assemblies 24A, 24B, and 24C include the seat base and a seat back 28 which may extend the entire width of the third row of seating 24. The seat back 28 of the third row of seating 24 may be fixed generally up against a rear wall 15 of the passenger compartment 14 and as such may not be adjustable in terms of incline or recline. The seat base 26 of the third row of seating 24 may be actuated to pivot upwards to a folded upright stowed position to allow for enhanced access or storage in the passenger compartment 14.

The first row of seating 20 and the second row of seating 22 includes seats that are mounted or assembled onto a seating rail system having pairs of rails 30 and 32 that may form tracks that extend on the floor 18 longitudinally in the vehicle passenger compartment 14 to allow each of the seat assemblies 20A-20D to move forward and rearward. To do so, each of the seat assemblies 20A and 20B and 22A and 22B is coupled to a pair of rails 30 or 32 or tracks on opposite lateral sides and is actuated via a seat linear motor 50 and gear 52, for example, to move the corresponding seat vehicle forward or rearward on the pair of rails or tracks.

In addition, the motor vehicle 10 has a center console 36 generally located between the first seat assembly 20A and the second seat assembly 20B as seen in FIG. 2. The center console 36 is mounted onto a center console rail system having a pair of rails 34 that may form tracks that extend on the floor 18 longitudinally in the vehicle passenger compartment 14. As such, the center console 36 may move vehicle forward to the position shown in FIG. 2 or may move vehicle rearward to a position located between the third seat assembly 22A and the fourth seat assembly 22B in the second row of seats 22 and presented in front of the third row of seating 24, particularly directly in front of the sixth seat assembly 24B. The center console 36 is actuated to move vehicle rearward and forward with an actuator having a center console motor 58 and may include a gear, according to one example. The third and fourth seat assemblies 22A and 22B arranged in the second row of seating 22, further include a swivel actuator having a seat swivel motor 62 that may actuate the corresponding seat assembly to rotate or swivel the seat assembly about a vertical axis such as to move from a normally vehicle forward-facing position ninety degrees) (90° to a lateral or one hundred eighty degrees) (180° to a vehicle rearward-facing position. The rails or tracks may include slide rails operatively coupled to tracks that allow the rails to slide relative to the tracks.

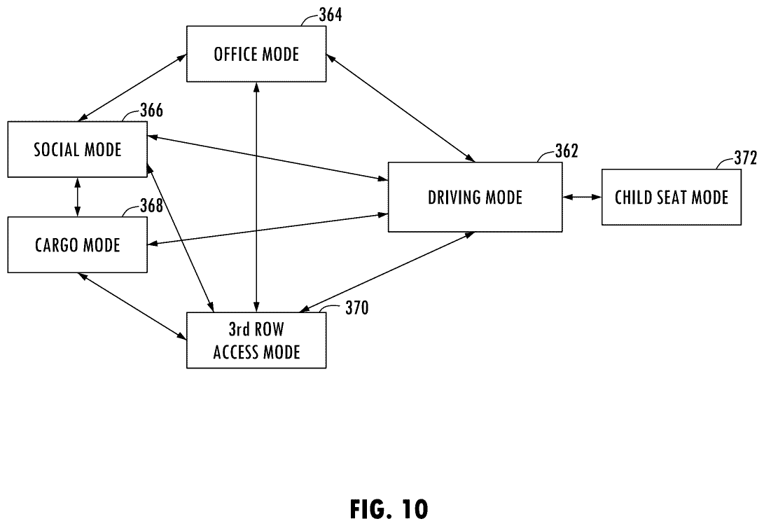

It should be appreciated that the movement of the seat assemblies and the center console are realized to achieve a user selected passenger compartment arrangement in response to a user input. The user input may include a touchscreen display 38, a portable electronic device such as a phone 46, or a key fob 48, or a microphone to receive spoken input commands, or a hand gesture device to detect gesture inputs via a camera or other sensor for example. The seating assemblies and center console may be positioned in a plurality of selectable passenger compartment arrangements which are shown in FIGS. 2-9, for example. The passenger compartment arrangements with the seating and center console positioning may be moved between the plurality of selectable modes as shown in the state diagram shown in FIG. 10, according to one example.

In FIG. 2, the motor vehicle 10 is shown arranged in a driving mode which is the normal customary forward-facing seating arrangement with the center console 36 located between the front and second seat assemblies 20A and 20B in the front row of seating 20. In this arrangement, occupants including the driver and passengers are all generally seated forward facing and the center console 36 is positioned and available for the driver and front row passenger to rest their arm on the console lid/armrest and to position one or more drink containers or other items on the center console 36.

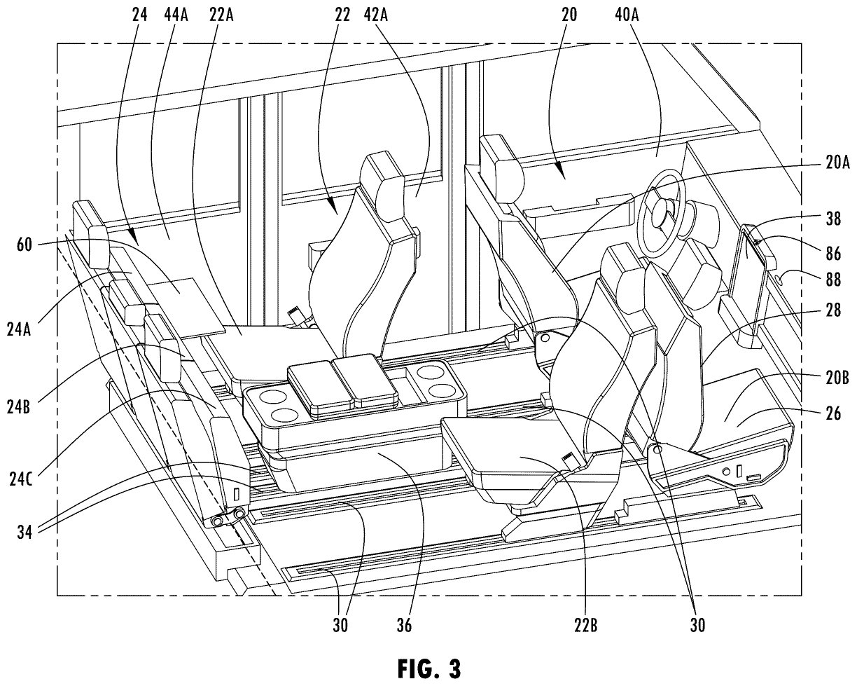

The seating assemblies and the center console 36 are movable to other locations and positions such as the office mode passenger compartment arrangement as shown in FIG. 3. In this office mode arrangement, the third and fourth seat assemblies 22A and 22B in the second row of seating are swiveled and rotated one hundred eighty degrees (180°) to face vehicle rearward. In addition, the seat base of the third row of seating is actuated upwards to a vertical position and a worktable 60 is deployed to provide the worktable 60 in front of the third seat assembly 22A. Additionally, the center console 36 is actuated to a vehicle rearward position to place the center console 36 adjacent to the third and fourth seat assemblies 22A and 22B. In this position, one or more occupants of the motor vehicle 10 may be presented with a work environment. In the office mode arrangement, the motor vehicle 10 is generally expected not to be operating, is to be in park, and not moving.

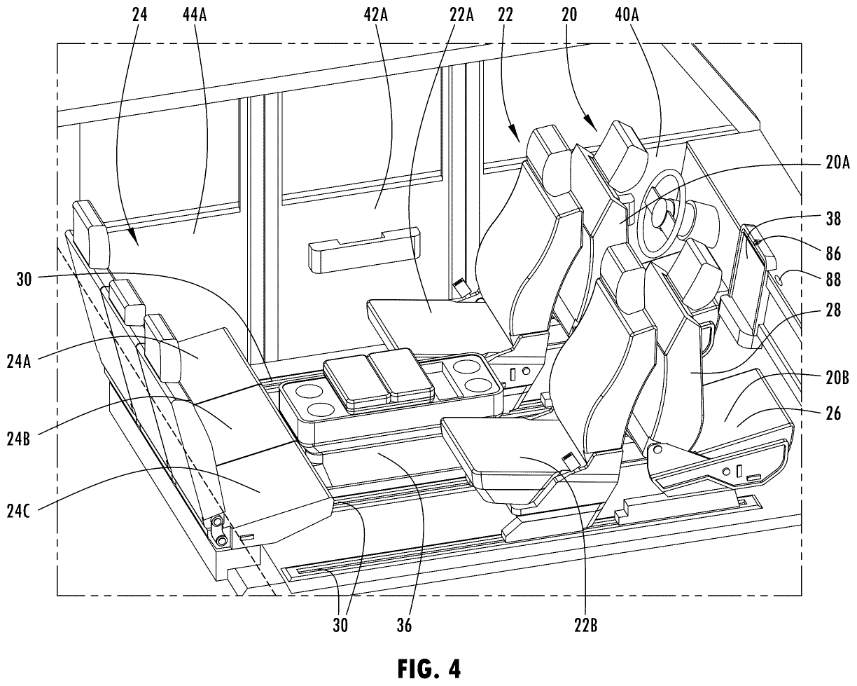

Referring to FIG. 4, the vehicle passenger compartment 14 interior is shown in a social mode arrangement with the third and fourth seat assemblies 22A and 22B of the second row of seating 22 shown in a vehicle rearward-facing position generally facing the third row of seating 22 with the seat base of a third row of seating 24 in the downward horizontal or seating position and the center console 36 is generally positioned rearward in the motor vehicle 10. In the social mode arrangement, the motor vehicle 10 is generally expected not to be operating, is to be in park, and not moving.

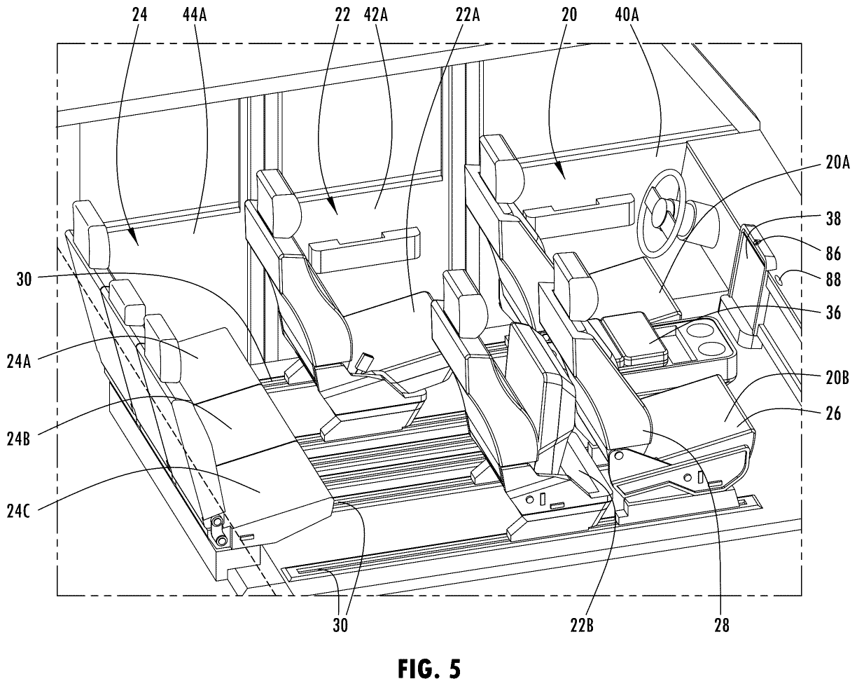

Referring to FIG. 5, the passenger compartment 14 of the motor vehicle 10 is shown having the seating assemblies and center console 36 arranged in a third row access mode. In this mode, the fourth seat assembly 22B in the second row of seating 22 is actuated to a forward position with the seat base actuated upward so as to be compactly located behind the second seat assembly 20B. In addition, the second seat assembly 20B is preferably actuated to a forwardmost position. The seat base of the third row of seating assembly is presented in the horizontal seating position. The center console 36 remains in the generally forward position. In this configuration, an enlarged open space is presented between the fourth seating assembly 22B and the third row of seating 24 to allow access to the third row of seating. It should be appreciated that the second and third rows of doors may provide a sufficiently large opening to access the passenger compartment 14 of the motor vehicle 10 in this configuration.

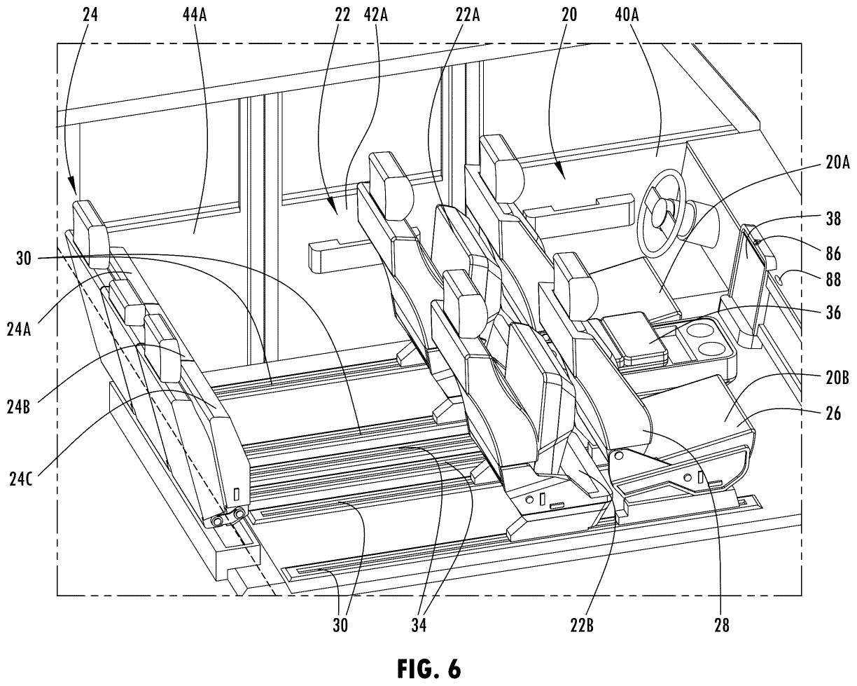

In FIG. 6, the passenger compartment 14 of the motor vehicle 10 is illustrated in a first cargo mode which offers an enlarged storage area within the rear portion of the passenger compartment 14. In the first cargo mode, the third and fourth seat assemblies 22A and 22B of the second row of seating 22 have the seat bases folded to the upright stowed position and the seat assemblies are actuated to a forwardmost position. In addition, the seat base of the third row of seating 24 is actuated to an upright stowed position. As a result, an enhanced area for storage is presented between the third row of seating 24 and second row of seating 22.

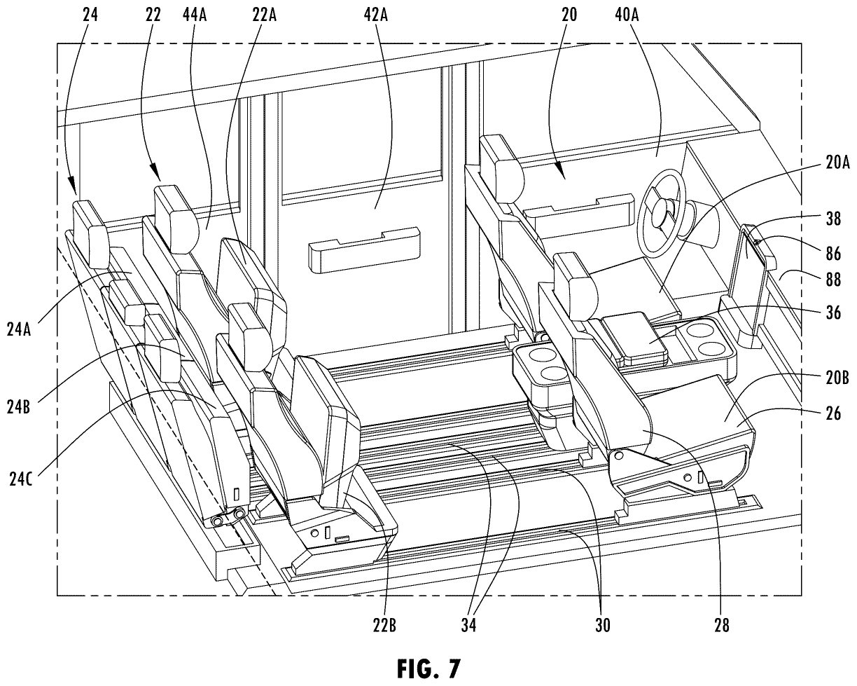

In FIG. 7, the passenger compartment 14 of the motor vehicle 10 is illustrated in a second cargo mode configuration. In this configuration, the third and fourth seat assemblies 22A and 22B are folded such that the seat base is folded upwards to a stowed position and the third and fourth seat assemblies 22A and 22B are actuated to the rearmost position in the passenger compartment 14 of the motor vehicle 10 with the seat base on the third row of seating 24 in the stowed position. In this position, an enlarged area for storage is provided between the first row of seating 20 and second row of seating 22. This is particularly useful for when moving cargo into and out of the passenger compartment 14 with the motor vehicle 10 via the second row of doors 42A and 42B and third row of doors 44A and 44B.

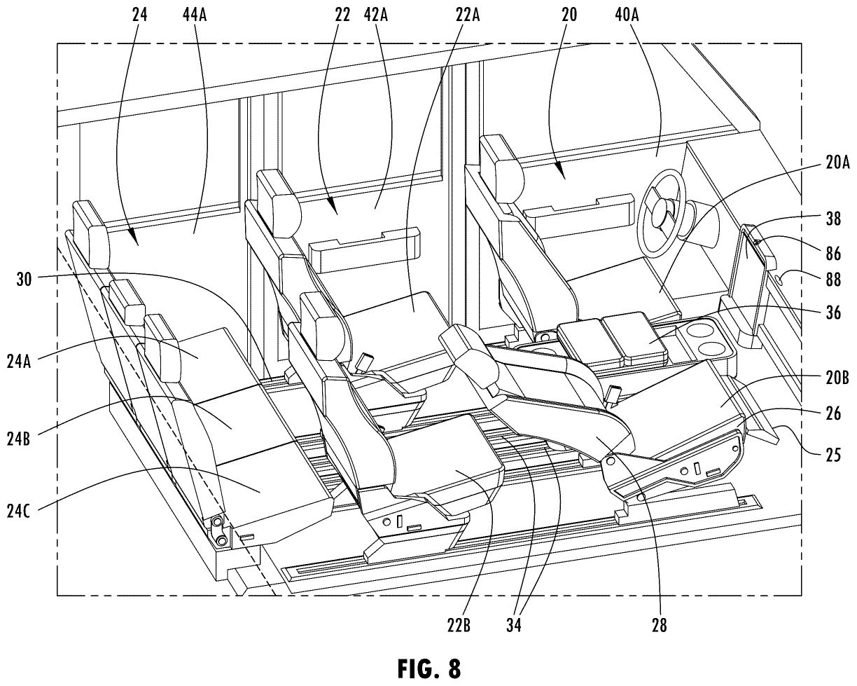

In FIG. 8, the passenger compartment 14 of the motor vehicle 10 is illustrated arranged in a relaxed mode, according to one example. In this mode, the second seat assembly 20B is actuated to a reclined position in which the seat back is reclined rearward and the remaining seat assemblies are generally shown positioned in a vehicle forward orientation. In the relaxed mode arrangement, the motor vehicle 10 is generally expected not to be operating, is to be in park, and not moving.

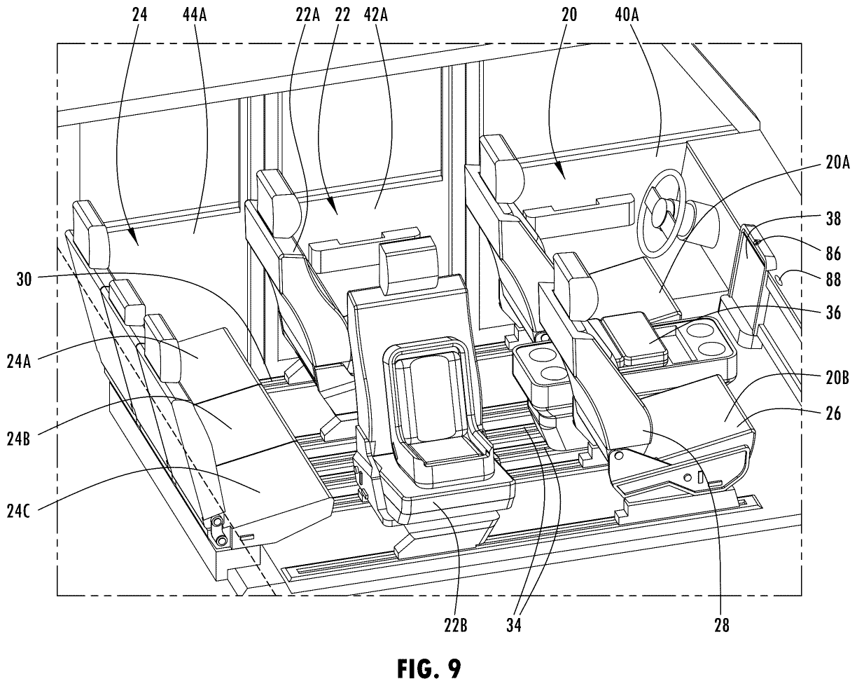

In FIG. 9, the passenger compartment 14 of the motor vehicle 10 is illustrated arranged in a child seat mode arrangement. In this arrangement, the fourth seat assembly 22B in the second row of seating 22 is rotated about a vertical axis to swivel ninety degrees) (90° to a lateral-facing position facing the middle door on the same side of the motor vehicle 10. In this position, a young child, e.g., infant, may be easily loaded or unloaded into a base seat or into the seat itself from an open door on the side of the motor vehicle 10. The remaining seats may remain in their generally vehicle forward-facing positions. In the child seat mode arrangement, the motor vehicle 10 is generally expected not to be operating, is to be in park, and not moving.

Referring to FIG. 10, a plurality of selectable passenger compartment arrangement modes are illustrated according to a state diagram. It should be appreciated that the state diagram includes each of the selectable modes shown in FIGS. 2-9. In the example shown, the state diagram includes the driving mode 362, the child seat mode 372, the office mode 364, the social mode 366, the cargo modes 368, which may include the first and second cargo modes, and the third row access mode 370. Additional modes such as the relaxed mode, for example, may be included in other examples. It should be appreciated that the seating and center console configuration may change from one mode to another mode based on user selectable inputs. It should also be appreciated that when the motor vehicle 10 is in a first user-selected mode, the motor vehicle 10 may transition from any one mode as shown by the state diagram to any other different mode upon request by a user providing an input through a user input device such as a phone 46, a key fob 49, or an input on a user device 38 including the touch screen display or a microphone, or a gesture detecting device, or other input devices.

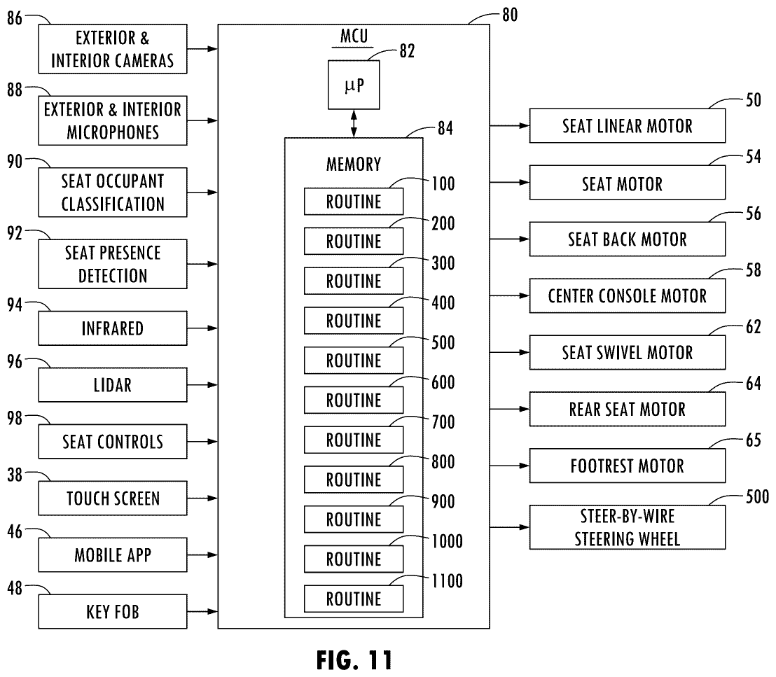

The motor vehicle 10 is equipped with a controller 80 that controls the operation and actuation of the various seating assemblies and center console to achieve a user selected passenger compartment arrangement pursuant to the passenger seating and center console mode. The controller 80 is shown in FIG. 11, according to one example. The controller 80 may include a microprocessor 82 or other analog and/or digital circuitry. In addition, the controller 80 may include memory 84, which may be configured to store one or more routines 100, 200, 300, 400, for controlling actuation of the seat assemblies, the center console and a steering wheel to a particular passenger compartment arrangement based on the user selected mode. Further, the setpoints for each of the seats and the center console in the various positions may be stored in memory 84.

The controller 80 receives various inputs which, in the example shown, includes inputs from the exterior and interior cameras 86, inputs from the exterior and interior microphones 88, the seat occupant classification 90, the seat presence detection 92, signals from infrared sensor 94, signals from one or more lidar sensors 96, seat control inputs 98, as well as inputs from the touchscreen 38, a microphone 88, a camera 86, a mobile app 46, and from the key fob 48. The controller 80 may process the various inputs with one more of the routines 100, 200, 300, 400, 510, 600, 700, 800, 900, 1000, 1100 to generate control signals to control various output devices. In the example shown, the output devices may include the seat linear motors 50 for each seat, the seat motors 54 for each seat, the seat back motors 56 for each seat, the center console motor 58, the seat swivel motors 62 for each seat, the rear seat motors 64 for each seat, the footrest motors 65 associated with each seating assembly or the center console and a steer-by-wire steering system 500. By controlling actuation of the various motors, the configuration of the seating arrangement, the center console and the steering wheel amongst the plurality of passenger compartment modes may be controlled.

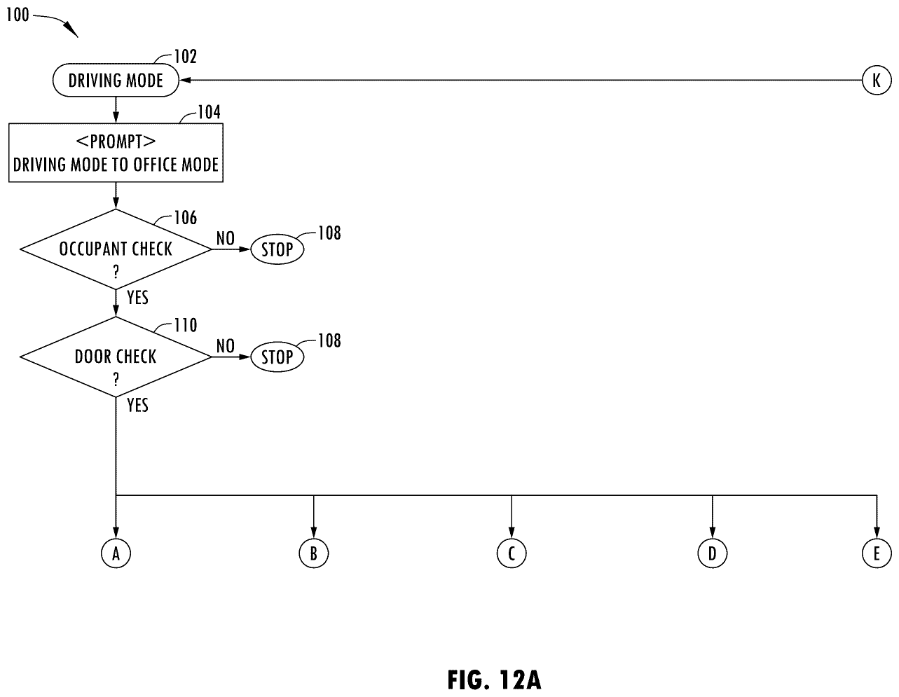

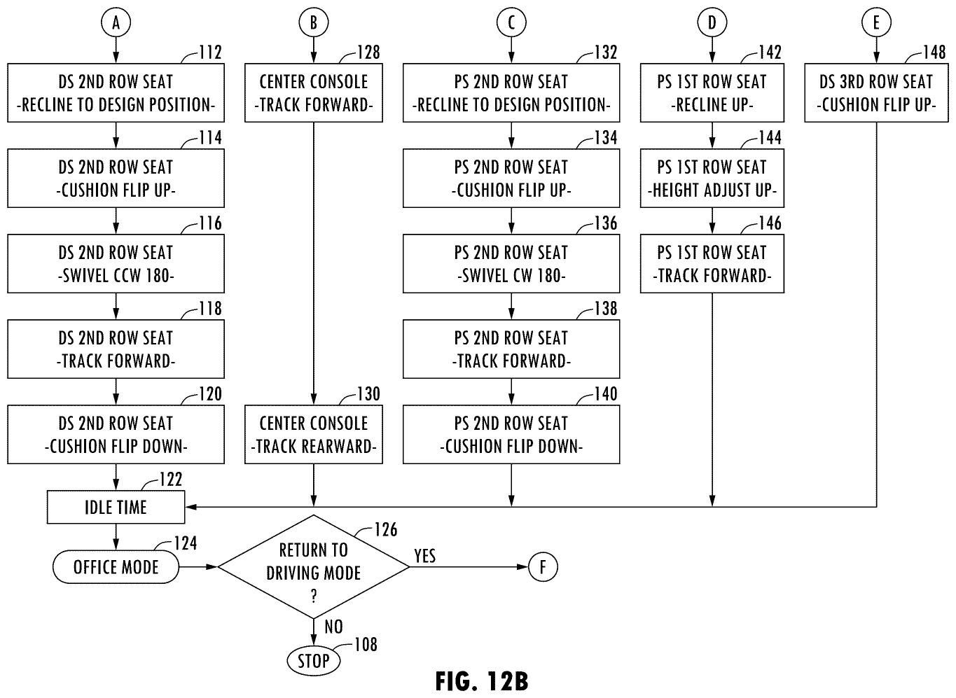

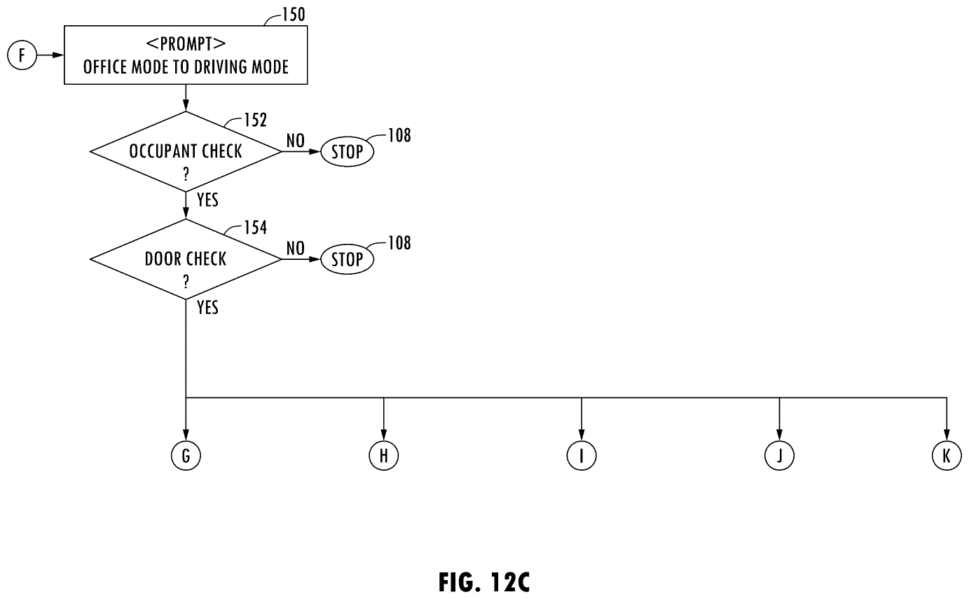

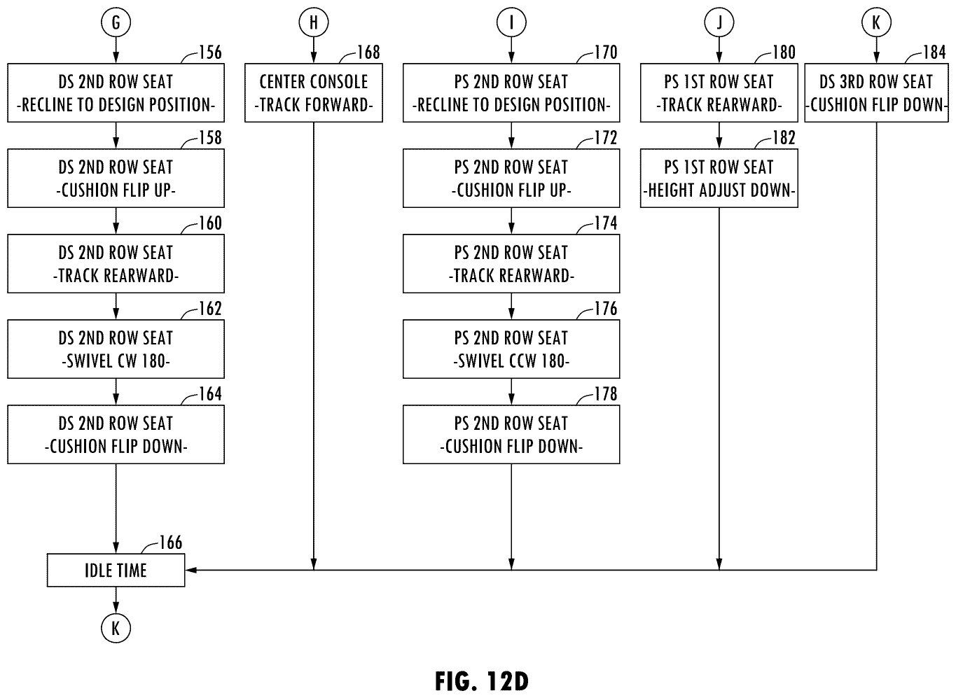

Referring to FIGS. 12A-12D, a control routine 100 is illustrated for transitioning the vehicle passenger compartment between the driving mode and the office mode, according to one example. Routine 100 begins at step 102 in the driving mode and proceeds to step 104 to receive a user input prompt to transition from the driving mode to the office mode. Routine 100 then proceeds at the decision step 106 to check for occupants in the vehicle. If one or more occupants are detected in the vehicle, routine 100 will stop at stop 108. If no occupants are detected in the vehicle, routine 100 proceeds to perform a door check at step 110. If there is a door open, routine stops at step 108. Otherwise, if no doors are detected open, routine 100 proceeds to each of steps 112, 128, 132, 142, and 148.

At step 112, routine 100 will adjust the driver's side second row seat to recline to the design position which is the normal vehicle forward facing seating position. Next, at step 114, the driver's side second row seat cushion will be flipped to an upright position. At step 116, the driver's side second row seat will swivel counter-clockwise one hundred eighty degrees) (180° to face vehicle rearward. Next, at step 118, the driver's side second row seat track will move forward and, at step 120, the driver's side second row seat cushion will flip down to the seated position. Routine 100 then proceeds to step 122 to wait for an idle time to expire before proceeding to step 124 to complete entry to the office mode.

At step 128, routine 100 will command the center console to move forward on the track or rails and proceed to step 130 to command the center console track to move vehicle rearward. Routine 100 will then wait for the idle time to expire at step 122 before proceeding to complete entry to the office mode at step 124.

At step 132, the passenger side second row seat is commanded to recline to the design position. Next, at step 134, the passenger side second row seat is commanded to flip up the cushion to the upright position. At step 136, the passenger side second row seat is commanded to swivel clockwise about a vertical axis one hundred eighty degrees (180°) to face vehicle rearward. At step 138, the passenger side second row seat is commanded to move forward on the track or rails. At step 140, the passenger seat second row seat cushion is commanded to flip down to the seating position before proceeding to wait for the idle time to expire at step 122 and then proceeds to complete entry to the office mode at step 124.

At step 142, the passenger side first row seat is commanded to recline up. Next, at step 144, the passenger side first row seat is adjusted upwards in height. Thereafter, the passenger side first row seat is moved forward on the track at step 146 and then routine 100 waits for the idle time to expire at step 122 before proceeding to complete entry to the office mode at step 124.

At step 148, the driver's side third row seat is commanded to flip up the cushion to the upright position. Thereafter, routine 100 waits for the idle time to expire at step 122 before proceeding to complete entry to the office mode at step 124.

After completing entry to the office mode at step 124, routine 100 proceeds to decision step 126 to determine whether the seating arrangement should return to the driving mode and, if not, stops at step 108. If the passenger seating arrangement is determined to return to the driving mode, routine 100 proceeds to step 150 to receive a user input prompt from the user to transition from the office mode to the driving mode. Next, at decision step 152, routine 100 performs an occupant check. If occupants are detected pursuant to this check, routine 100 stops at step 108. If there are no occupants detected, routine 100 proceeds to perform a door check at step 154. If any doors are determined to be open, routine 100 stops at step 108. If the door check shows the doors are closed, routine 100 proceeds to each of steps 156, 168, 170, 180, and 184.

At step 156, routine 100 commands the driver's side second row seat to move from the recline position to the design position. Next, at step 158, the driver's side second row seat cushion is commanded to flip up to an upright position. Next, at step 160, the driver's side second row seat is moved vehicle rearward on the track or rails. At step 162, the driver's side second row seat is rotated to swivel clockwise about a vertical axis one hundred eighty degrees) (180° to face vehicle forward. Next, at step 164, the driver's side second row seat cushion is flipped down to the use position before proceeding to step 166 to wait out an idle time to expire.

At step 168, routine 100 commands the center console to move forward on the track or rails. Thereafter, routine 100 proceeds to wait for the idle time to expire at step 166.

At step 170, the passenger side second row seat is commanded to move from the recline position to the design position. At step 172, the passenger side second row seat is commanded to flip up the cushion to the upright position. At step 174, the passenger side second row seat is commanded to move vehicle rearward on the track or rails. At step 176, the passenger side second row seat is commanded to rotate to swivel counterclockwise one hundred eighty degrees) (180° to the vehicle forward facing position. At step 178, the passenger side second row seat cushion is commanded to flip down to the use position. Thereafter, routine 100 proceeds to wait for the idle time to expire at step 166.

At step 180, the passenger side first row seat is commanded to move vehicle rearward on the track. Next, at step 182, the passenger side first row seat is commanded to be adjusted downwad in height. Thereafter, routine 100 waits for the idle time to expire at step 166.

At step 184, the driver's side third row seat cushion is commanded to flip down to the use position. Thereafter, routine 100 waits for the idle time to expire at step 166. Following expiration of the idle time at step 166, routine 100 returns to step 102 with the seating and center console arranged in the driving mode.

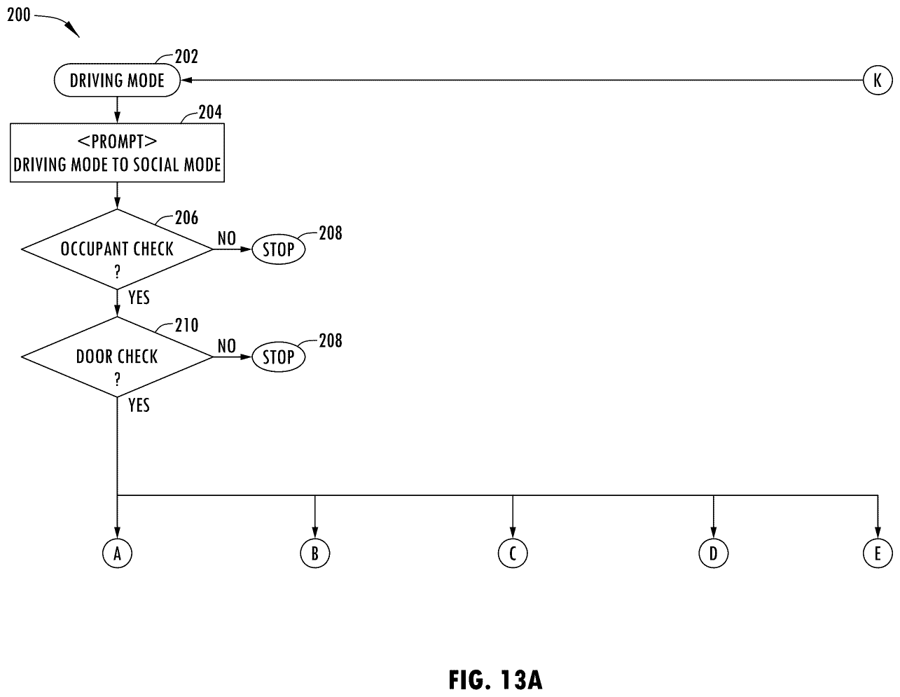

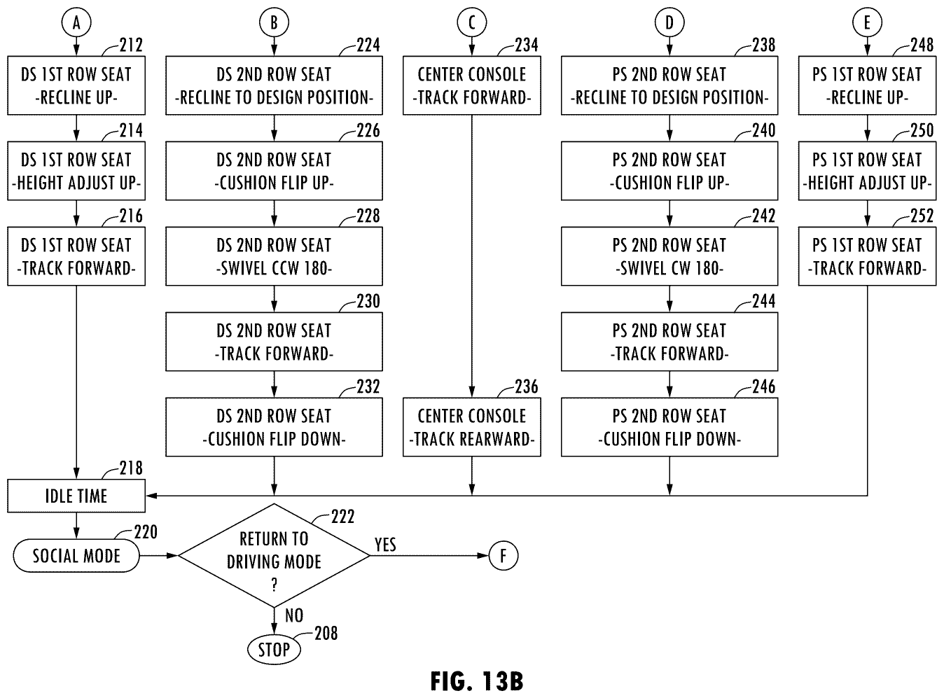

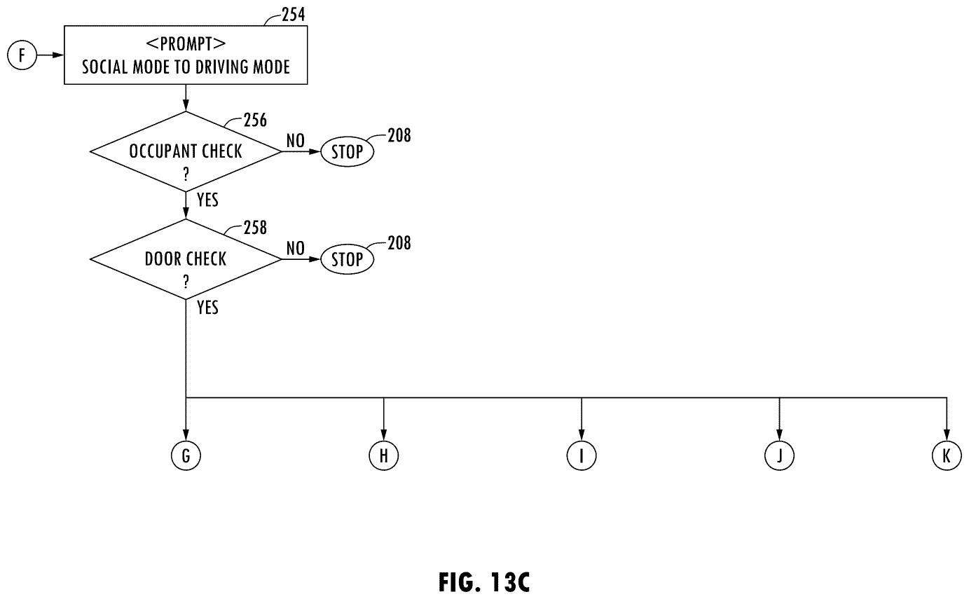

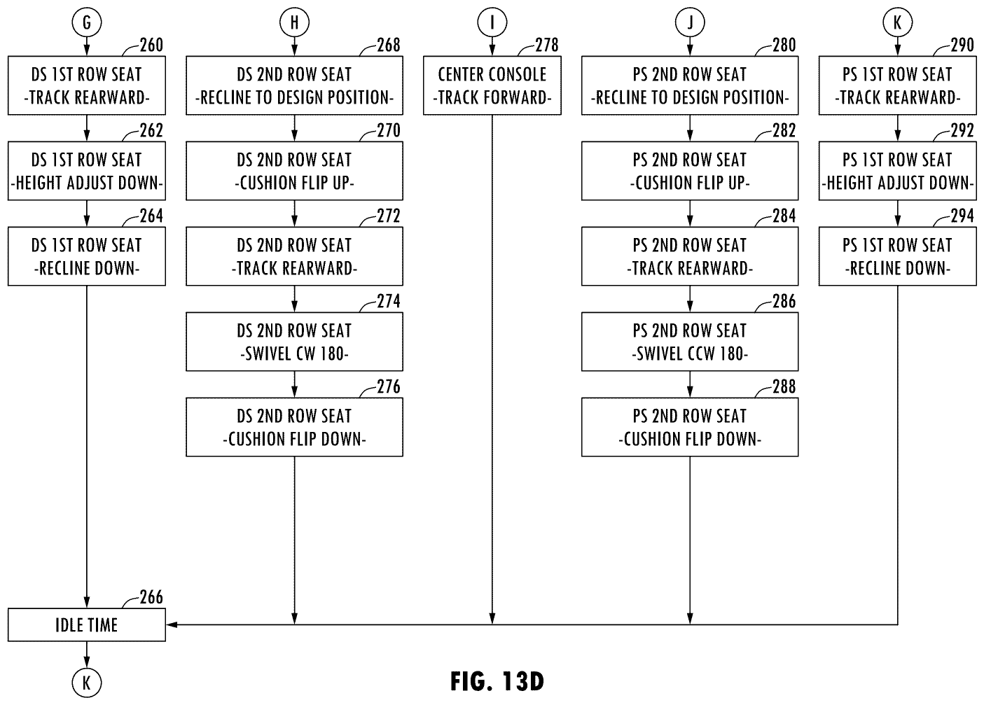

Referring to FIG. 13A, a control routine 200 is illustrated for transitioning the vehicle passenger compartment from the driving mode to the social mode, according to one example. Routine 200 begins at step 202 in the driving mode and proceeds to step 204 to receive a user input prompt to transition from the driving mode to the social mode. Routine 200 will then proceed to decision step 106 to perform an occupant detection check and to verify there are no obstructions. It should be appreciated that an interior camera and other sensors may be used to detect an obstruction in the movement path of the seating assemblies, and the center console may use the sensed signals to allow the transitions to occur only when there are no obstructions in the movement path. If occupants are detected seated in the vehicle, routine 200 will stop at step 208. If no occupants are detected in the vehicle, routine 200 will proceed to perform a door check to check if any doors are open. If any doors are detected open, routine 200 will stop at step 208. If all of the doors are closed, routine 200 proceeds to each of step 212, step 224, step 234, step 238 and step 248.

At step 212, routine 200 commands the driver's side first row seat to recline forward to an upward position. Next, at step 214, the driver's side first row seat is adjusted upward in height. At step 216, the driver's side first row seat is moved vehicle forward on the track. Thereafter, routine 200 proceeds to wait for an idle time to expire at step 218 before entering completion of the social mode at step 220.

At step 224, the driver's side second row seat is commanded to move from the recline position to the design position. Next, at step 226, the driver's side second row seat is commanded to flip up the cushion to the upright position. The driver's side second row seat is then rotated to swivel counterclockwise about a vertical axis by one hundred eighty degrees) (180° in step 228. In step 230, the driver's side second row seat is commanded to move vehicle forward on the track. At step 232, the driver's side second row seat is commanded to flip the cushion down to the use position. Thereafter, routine 200 will wait for the idle time to expire at step 218 before entering completion of the social mode at step 220.

At step 234, the center console is commanded to move vehicle forward on the track. Next, at step 236, the center console is moved vehicle rearward on the track. Thereafter, routine 200 proceeds to wait for the idle time to expire at step 218 before entering completion to the social mode at step 220.

At step 238, the passenger side second row seat is commanded to move from the recline position to the design position. Next, at step 240, the passenger side second row seat is commanded to flip up the cushion to the upright position. Next, at step 242, the passenger side second row seat is commanded to rotate to swivel clockwise about a vertical axis by one hundred eighty degrees) (180° to face vehicle backwards. In step 244, the passenger side second row seat is commanded to move vehicle forward on the track. At step 246, the passenger side second row seat cushion is commanded to be flipped down to the use position. Thereafter, routine 200 proceeds to wait for the idle time to expire at step 218 before entering completion of the social mode at step 220.

At step 248, the passenger side first row seat is commanded to recline forward and upward to an upright position. At step 250, the passenger side first row seat is adjusted in height upwards. Next, at step 256, the passenger side first row seat is commanded to move forward on the track. Thereafter, routine 200 waits for the idle time to expire at step 218 before entering the social mode at step 220.

In the social mode at step 220, routine 200 proceeds to decision step 222 to determine if the vehicle is to return to the driving mode and, if not, stops at step 208. If it is determined that the vehicle is to return to the driving mode, routine 200 proceeds to step 254 to wait for a user input prompt to transition from the social mode to the driving mode. Once the user input prompt is received, routine 200 performs an occupant check at step 256. If occupants are detected in the vehicle, routine 200 stops at step 208. If no occupants are detected in the vehicle, routine 200 performs a door check at step 258. If a vehicle door is detected open, routine 200 stops at step 208. If no vehicle doors are detected open, routine 200 proceeds to each of step 260, step 268, step 278, step 280, and step 290.

At step 260, the driver's side first row seat is commanded to move vehicle rearward on the track. Next, at step 262, the driver's side first row seat is adjusted downward in height. At step 264, the driver's side first row seat is commanded to recline downward. Thereafter, routine 200 proceeds to wait for an idle time to expire at step 266 before returning to the driving mode at step 202.

At step 268, the driver's side second row seat is commanded to move from the recline position to the design position. At step 270, the driver's side second row seat is commanded to flip up the cushion to the upright position. At step 272, the driver's side second row seat is commanded to move vehicle rearward on the track. At step 274, the driver's side second row seat is commanded to rotate to swivel clockwise by one hundred eighty degrees) (180° to face vehicle forward. At step 276, the driver's side second row seat is commanded to flip down the cushion. Thereafter, routine 200 waits for the idle time to expire at step 266 before returning to the driving mode at step 202.

At step 278, the center console is commanded to move vehicle forward on the track. Thereafter, routine 200 waits for the idle time to expire at step 266 before returning to the driving mode at step 202.

At step 280, the passenger side second row seat is commanded to move from the recline position to the design position. Next, at step 282, the passenger side second row seat is commanded to flip up the seat cushion to the upright position. At step 284, the passenger seat second row seat is commanded to move rearward on the track. At step 286, the passenger side second row seat is commanded to rotate to swivel counterclockwise one hundred eighty degrees) (180° to face vehicle forward. At step 288, the passenger side second row seat is commanded to flip down the seat cushion. Therefore, routine 200 proceeds to wait for the idle time to expire at step 266 before returning to the driving mode at step 202.

At step 290, the passenger side first row seat is commanded to move vehicle rearward on the track. Next, at step 292, the passenger side first row seat is commanded to adjust downward in height. At step 294, the passenger side first row seat is commanded to recline downward. Thereafter, routine 200 waits for the idle time to expire at step 266 before returning to the driving mode at step 202.

Following expiration of the idle time at step 266, routine 200 returns to step 202 with the vehicle passenger compartment arranged in the driving mode.

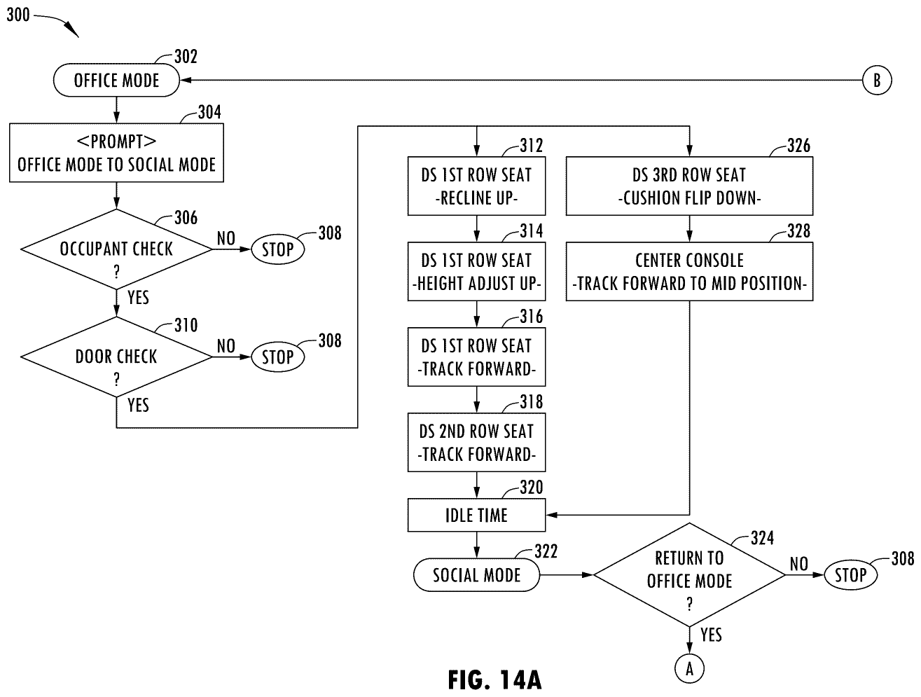

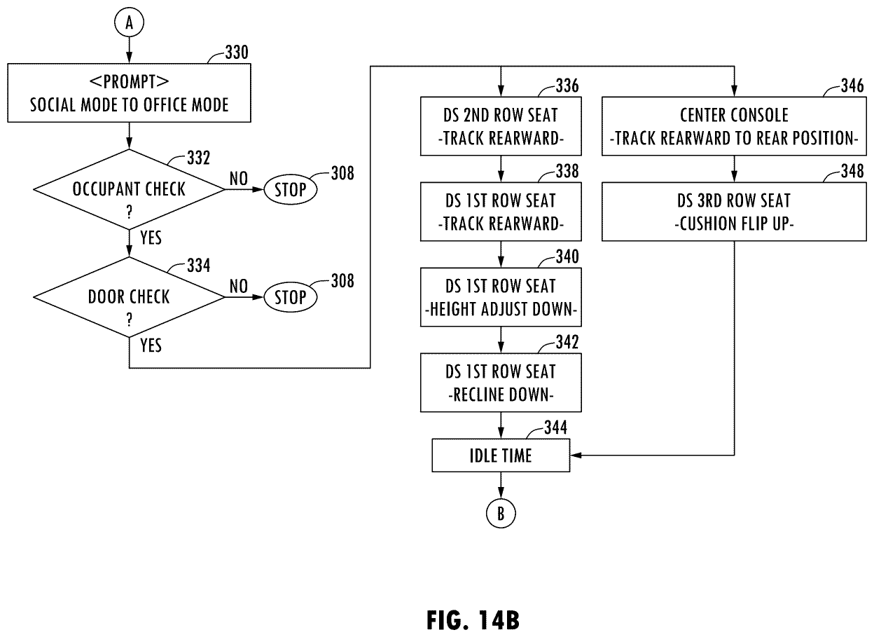

Referring to FIGS. 14A and 14B, a control routine 300 is illustrated for transitioning the vehicle passenger compartment from an office mode to a social mode, according to one example. Routine 300 begins at step 302 in the office mode and proceeds to step 304 to receive a user prompt to transition from the office mode to the social mode. Routine 300 then proceeds to decision step 306 to perform an occupant check. If one or more occupants are detected seated in the vehicle, routine 300 proceeds to stop at step 308. If no occupants are in the vehicle, routine 300 proceeds to perform a door check at step 310. If any vehicle doors are detected open, routine 300 stops at step 308. If no doors are detected open, routine 300 proceeds to each of step 312 and step 326.

At step 312, the driver's side first row seat is commanded to recline upward. Next, at step 314, the driver's side first row seat is commanded to adjust upward in height. At step 316, the driver's side first row seat is commanded to move vehicle forward on the track. At step 318, the driver's side second row seat is commanded to move vehicle forward on the track. At step 320, routine 300 waits for an idle time to expire before completing the transition to the social mode at step 322.

At step 326, the driver's side third row seat is commanded to flip the seat cushion to the downward use position. Next, at step 328, the center console is commanded to move the vehicle forward to a mid-position on the track. Thereafter, routine 300 proceeds to wait for the idle time to expire in step 320 before transitioning to the social mode at step 322.

Once in the social mode, the routine 300 proceeds to decision step 324 to determine if the arrangement should return to the office mode and, if not, stops at step 308. If it is determined that the arrangement should return to the office mode, routine 300 proceeds to step 330 to receive a user input prompt to transition from the social mode to the office mode. Thereafter, routine 300 proceeds to perform an occupant check at step 332 to determine if one or more occupants are seated in the vehicle and that there are no obstructions detected with an interior camera. If any occupants are detected seated in the vehicle, routine 300 stops at step 308. If no occupants are detected in the vehicle, routine 300 performs at door check at step 334. If any doors are detected open, routine 300 stops at step 308. If no doors are detected open, routine 300 proceeds to each of step 336 and step 346.

At step 336, the driver's side second row seat is commanded to move vehicle rearward on the track. Next, at step 338, the driver's side first row seat is commanded to move rearward on the track. At step 340, the driver's side first row seat is commanded to adjust downward in height. At step 342, the driver's side first row seat is commanded to recline downward. At step 344, routine 300 waits for the idle time to expire before completing the transition to the office mode at step 302.

At step 346, the center counsel is commanded to move vehicle rearward on the track to the rear position. Next, at step 348, the driver's side third row seat cushion is commanded to flip up to an upright position. Thereafter, routine 300 waits for the idle time to expire at step 344 before completing the transition to the office mode at step 302.

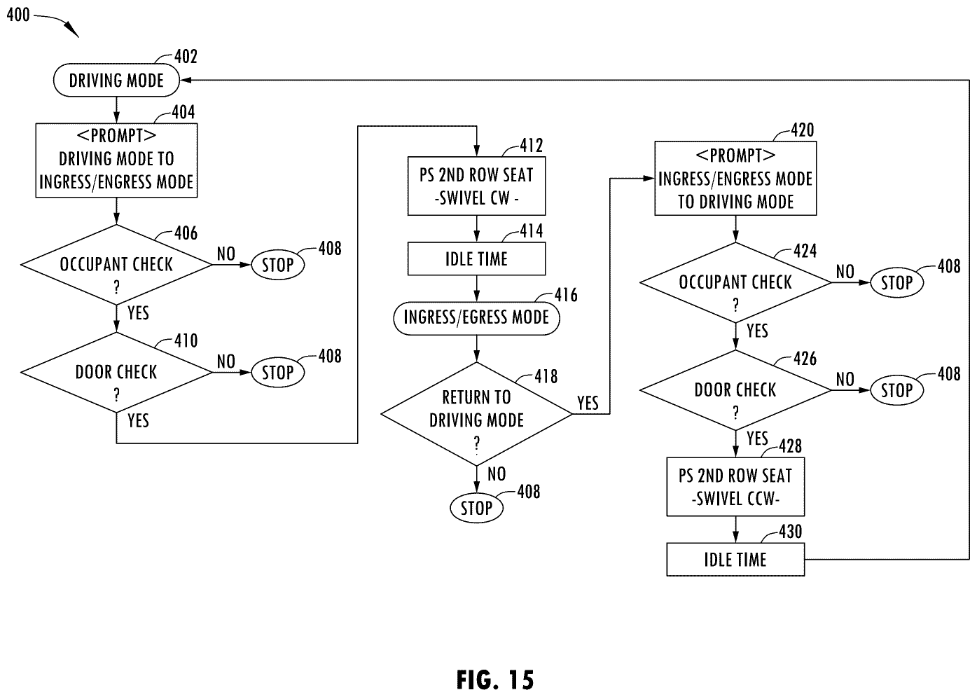

Referring to FIG. 15, a control routine 400 is illustrated for transitioning the vehicle passenger compartment from a driving mode to an ingress/egress mode, according to one example. Routine 400 begins at step 402 in the driving mode and proceeds to step 404 to receive a user input prompt to transition from the driving mode to the ingress/egress mode. Routine 400 will then proceed to decision step 406 to perform an occupant check. If one or more occupants are detected seated in the vehicle, routine 400 will stop at step 408. If there are no occupants detected in the vehicle, routine 400 proceeds to decision step 410 to perform a door check. If any doors are detected open, routine 400 stops at step 408. If there are no doors detected open, routine 400 proceeds to step 412.

At step 412, the passenger side second row seat is rotated to swivel about a vertical axis clockwise one hundred eighty degrees) (180° to a vehicle rearward facing position. Next, at step 414, routine 400 waits for an idle time to expire. Following expiration of the idle time, routine 400 proceeds to step 416 to complete the transition to the ingress/egress mode.

Once in the ingress/egress mode, routine 400 proceeds to decision step 418 to determine if the vehicle is to return to the driving mode and, if not, stops at step 408. If it is determined that the vehicle is to return to the driving mode, routine 400 proceeds to step 420 to receive a user input prompt to transition from the ingress/egress mode to the driving mode. Once the user input prompt is received, routine 400 proceeds to perform an occupant check at step 424. If one or more occupants are detected in the vehicle, routine 400 proceeds to step 408 to stop. If there are no occupants detected in the vehicle, routine 400 proceeds to decision step 426 to perform a door check. If any doors are detected open, routine 400 stops at step 408. If there are no doors detected open, routine 400 proceeds to step 428 where the passenger side second row seat is commanded to rotate to swivel counterclockwise one hundred eighty degrees (180°) to face vehicle forward. Thereafter, routine 400 waits for an idle time to expire at step 430 before transitioning completely to the driving mode.

It should be appreciated that the motor vehicle 10 may include additional control routines stored in memory 84 and executed by the microprocessor 82 to perform passenger compartment transitions from one mode to another mode. For example, the motor vehicle 10 may be configured to transition from the driving mode to the child load mode whereby the passenger side or driver's side second row seat is commanded to rotate to swivel ninety degrees) (90° from the driving mode passenger configuration to the child load passenger configuration to present the seat for loading a child thereon. The child load mode may transition back to the diving mode by reversing the process and rotating the second row seat ninety degrees) (90° in the opposite direction to face vehicle forward.

Similarly, the passenger compartment of the motor vehicle 10 may be equipped with a control routine to transition from the driving mode to the cargo mode. This may include flipping the seat bases upward on the third row seats and the second row seats and sliding the second row seats vehicle rearward proximate to the front side of the rear row seats, to present a cargo load area between the first and second rows of seats. This process may be reversed by moving the second row seats vehicle forward and flipping down the seat bases on the second and third rows to return the passenger compartment to the driving mode. It should be appreciated that other types of transitions of the passenger compartment between the various modes provided herein may transition from one mode to another by controlling the one or more actuators to move the seats and the center console amongst the various positions.

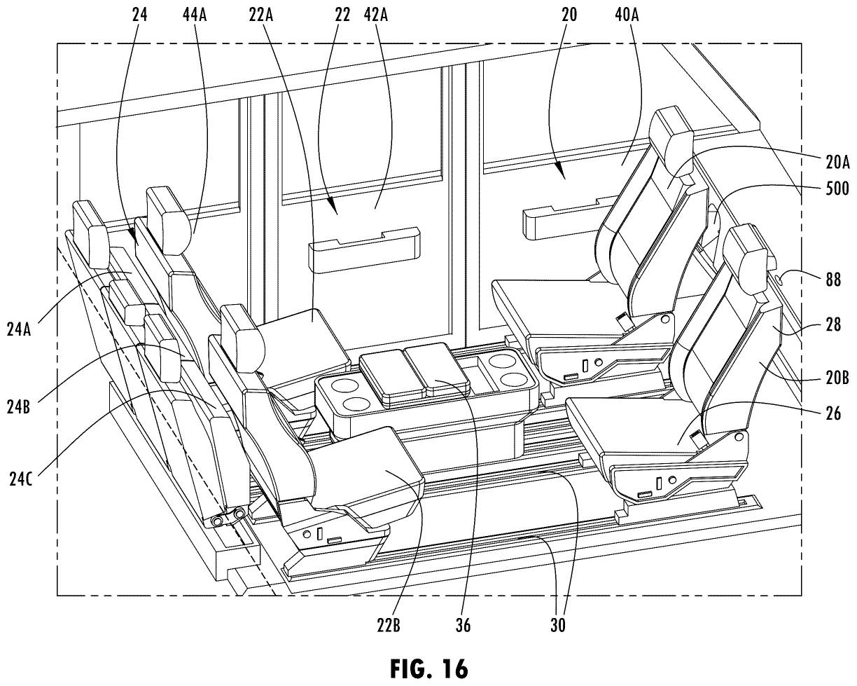

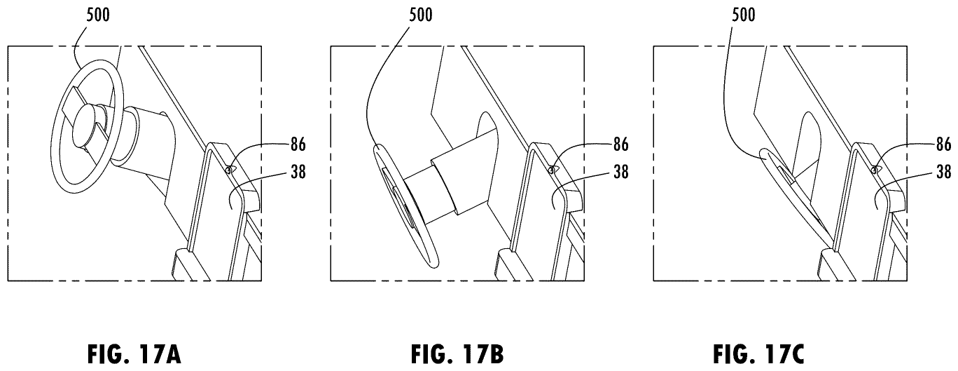

Referring to FIG. 16, a motor vehicle 10 is generally illustrated in the form of a pickup truck generally having a passenger compartment 14 with three rows of seating, according to another embodiment. The second and third rows of seating may be configured substantially as shown in connection with the embodiment shown in FIGS. 1-14. In this embodiment, the motor vehicle 10 employs a steer-by-wire steering wheel 500 located forward of the driver's seat 20A and extending rearward of the dashboard. The steer-by-wire steering wheel 500 is shown in FIGS. 17A-17C in several configurations. In this embodiment, the steer-by-wire steering wheel 500 is configurable to be manipulated from a use position shown in FIG. 17A to a partially stowed position shown in FIG. 17B and a fully stowed position shown in FIG. 17C. With the steering wheel 500 configured in the stowed position, the first seating assembly 20A which serves as the driver's seat may further be configurable to move to a plurality of positions to accommodate different passenger compartment configuration modes on the motor vehicle 10. In addition, the motor vehicle 10 may also be configured without a glove box on the front passenger side, which further enables the second seat assembly 20B which serves as the front passenger seat to be configurable into a plurality of different positions to accommodate a plurality of different seating configurations. This embodiment utilizing the steer-by-wire steering wheel 500 and a lack of a glove box accommodates additional seating configurations within the passenger compartment 14.

In the embodiment shown in FIG. 16, the motor vehicle 10 may be configured in any of a number of seating modes for the passenger compartment 14. For example, the motor vehicle 10 passenger compartment 14 may be arranged in a driving mode such as is shown in FIG. 2 which is the normal customary forward-facing seating arrangement with the center console 36 located between the front and second seat assemblies 20A and 20B in the front row of seating 20 and the steering wheel extended in the use position. In this arrangement, occupants including the driver and passengers are all generally seated forward facing and the center console 36 is positioned and available for the driver and front row passenger to rest their arm on the console lid/armrest and to position one or more drink containers or other items on the center console 36, and the steering wheel is available for steering the motor vehicle 10. The seating assemblies and center console as well as the steer-by-wire steering wheel 500 are moveable to other locations and positions such as a social or conference mode arrangement with the first and second seat assemblies 20A and 20B of the first row of seating 20 as shown arranged in a vehicle rearward-facing position generally facing the second row of seating 22 with the seat base of the third row seating 24 in the stowed vertical position and the center console 36 generally positioned between the first row of seating 20 and second row of seating 22 as shown in FIG. 16. In addition, the steer-by-wire steering wheel 500 is moved to the fully stowed position within or below the dashboard. This enables the first seat assembly 26A which serves as the driver's seat to be rotated to the rearward facing direction and moved vehicle forward to maximize the use of the cabin space in the passenger compartment 14. Further, the second seat assembly 20B may be rotated vehicle rearward and moved vehicle forward to an extended forward position provided by the lack of a glovebox in the center or in the instrument panel or dashboard. In the conference mode, the first and second seat assemblies 20A and 20B in the row first of seating 20 and the third and fourth seat assemblies 22A and 22B in the second row of seating 24, generally face each other with the center console 36 provided generally in the middle. This provides for a social or conference working environment within the passenger compartment 14 of the motor vehicle 10 when the vehicle 10 is stopped and not operating. In the conference mode arrangement, the motor vehicle 10 is expected not to be operating, and is to be in park and not moving.

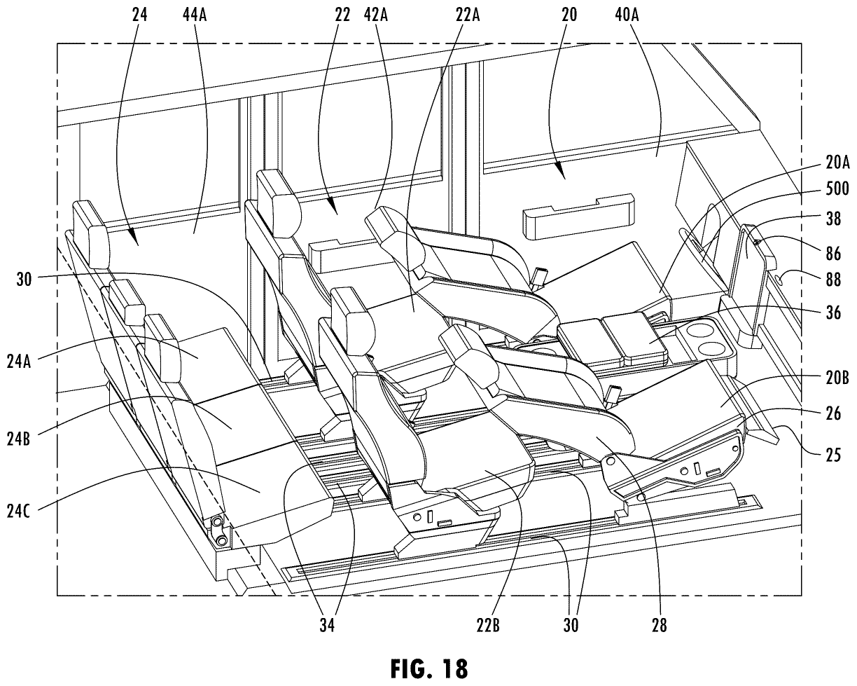

The vehicle passenger compartment 14 may be reconfigured to a relaxation mode that is vehicle front-facing as shown in FIG. 18 for the motor vehicle 10 as embodied in FIG. 16. In this relaxation mode, one or both of the first and second seating assembly 20A and 20B may be actuated to a reclined position in which the seat back 28 is reclined rearward and the remaining seat assemblies are generally shown positioned in a vehicle forward orientation. The third and fourth seat assemblies 22A and 22B in the second row of seating 22 may also recline the seat back 28 to a reclined position. The center console 36 is located in the vehicle forward position in the forward-facing relaxation mode. In addition, the steer-by-wire steering wheel 500 may remain in the stowed position so as to provide additional unobstructed space generally forward of the first seat assembly 20A. Additionally, the lack of a glovebox in front of the second seat assembly 20B allows for enhanced leg room. In the front-facing relaxation mode, the motor vehicle 10 is generally expected not to be operating, is to be in park, and not moving.

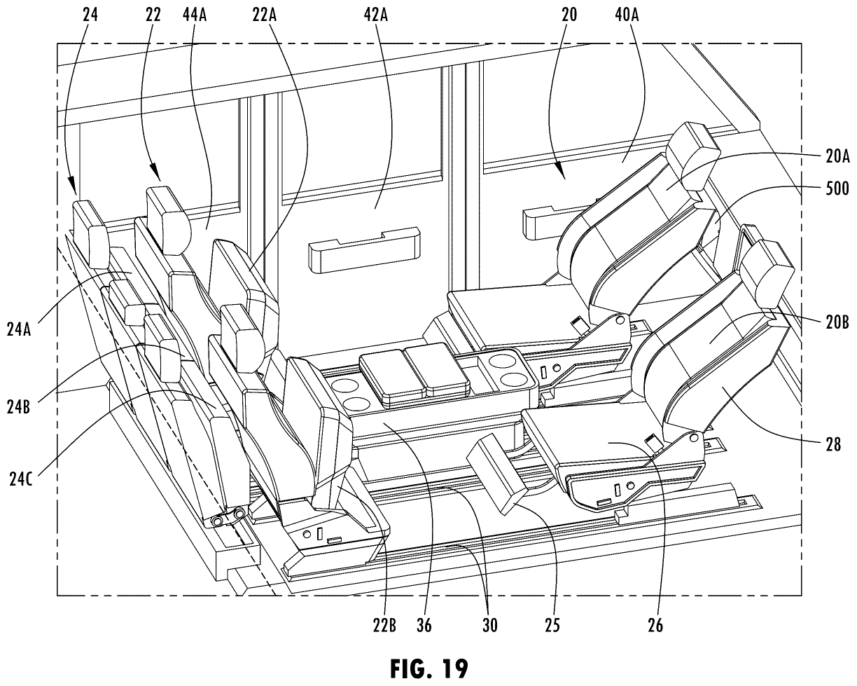

The passenger compartment 14 of the motor vehicle 10 may be transitioned to a rear-facing relaxation mode as shown in FIG. 19 for the motor vehicle 10 as embodied in FIG. 16. In this rearward facing relaxation mode, the first and second seat assemblies 20A and 20B are oriented vehicle rearward facing and the seat backs 28 are generally reclined to a reclined relaxation position. In addition, the second row of seating 22 has the third and fourth seat assemblies 22A and 22B configured in a stowed position and are moved vehicle rearward to abut the front side of the third row of seating 29 which is in the stowed position. This seating arrangement provides for an enhanced space between the first and second rows of seating to provide the occupants with enhanced space for the relaxation mode. In addition, the center console 36 is moved vehicle rearward in the rearward facing relaxation mode. In the rearward facing relaxation mode, the motor vehicle 10 is generally expected not to be operating, is to be in park, and not moving.

For the motor vehicle 10 configured according to the embodiment of FIG. 16, the controller 80 shown in FIG. 11 is configured to include a routine 510 that communicates with a user to receive a user input and to control the requested arrangement of the passenger compartment configuration. In addition, the controller 80 includes routines 510, 600, 700, 800, 900, 1000 and 1100 stored in memory 84 which are executed by the microprocessor 82 and configured to control transition from one passenger compartment mode to another passenger compartment mode. Routine 600 controls the transitioning from the driving mode to the first row/second row conference mode. Routine 700 controls the transition from the driving mode to the front facing relaxation mode. Routine 800 controls the transition from the driving mode to the rear facing relaxation mode. Routine 900 controls the transition from the conference mode to the front facing relaxation mode. Routine 1000 controls the transition from the front facing relaxation mode to the rear facing relaxation mode. Routine 1100 controls the transition from the conference mode to the rear facing relaxation mode.

The controller 80 processes each of the routines stored in memory depending on which embodiment is to be controlled and generates output signals. According to the embodiment in FIG. 16, the controller 80 may generate an output to the steer-by-wire steering wheel 500 to control the positioning of the steering wheel 500 in addition to controlling the seating arrangement and the arrangement of the center console.

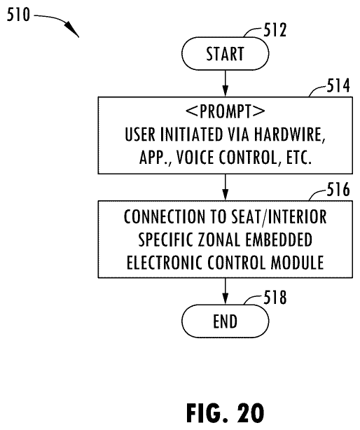

Referring to FIG. 20, routine 510 is shown according to one example. Routine 510 starts at step 512 and proceeds to step 514 to prompt a user for a user input. The user input may be entered via a hardware selection as on the touch screen display, on application software such as on a phone, via voice control with a microphone or other user inputs. Once the user input is received, routine 510 proceeds to step 516 to connect to the seat/interior specific zonal embodied electronic control module before ending at step 518. The specific zonal embodied electronic control module may be the controller configured to execute the controls according to a certain routine to transition between the various passenger compartment configurations as explained herein.

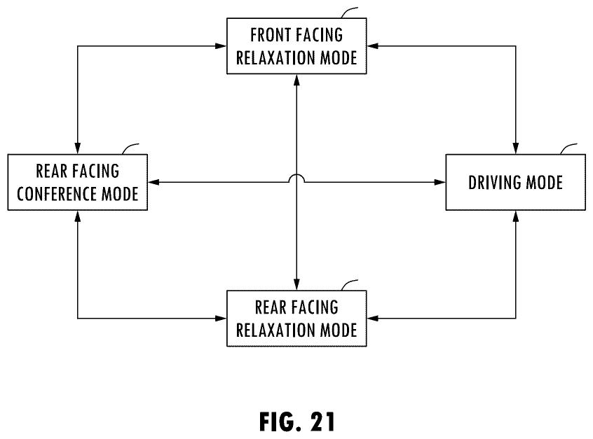

Referring to FIG. 21, a plurality of selectable passenger compartment arrangement modes are illustrating according to a state diagram in accordance with the embodiment of FIG. 16. It should be appreciated that the state diagram includes each of the selectable modes shown in FIG. 2, FIG. 16, FIG. 18 and FIG. 19. In the example shown, the state diagram includes the driving mode 362, the front facing relaxation mode 580, the rear facing relaxation mode 582, and the rear facing conference mode 584. Additional modes such as other office and social modes, the cargo mode, the third row access mode and the child seat mode are shown and described in connection with the state diagram shown in FIG. 10 and may likewise be included in other examples. It should be appreciated that the seating and center console configuration as well as the configuration of the steer-by-wire steering wheel 500 may change from one mode to another mode based on the user selectable inputs. It should also be appreciated that when the motor vehicle 10 is in a first user-selected mode, the motor vehicle 10 may transition from that mode as shown by the state diagram to any other different mode upon request by a user providing an input through a user input device such as a phone 46, a key fob 49, the touch screen display 38 or a microphone or a gesture detecting device or other input devices.

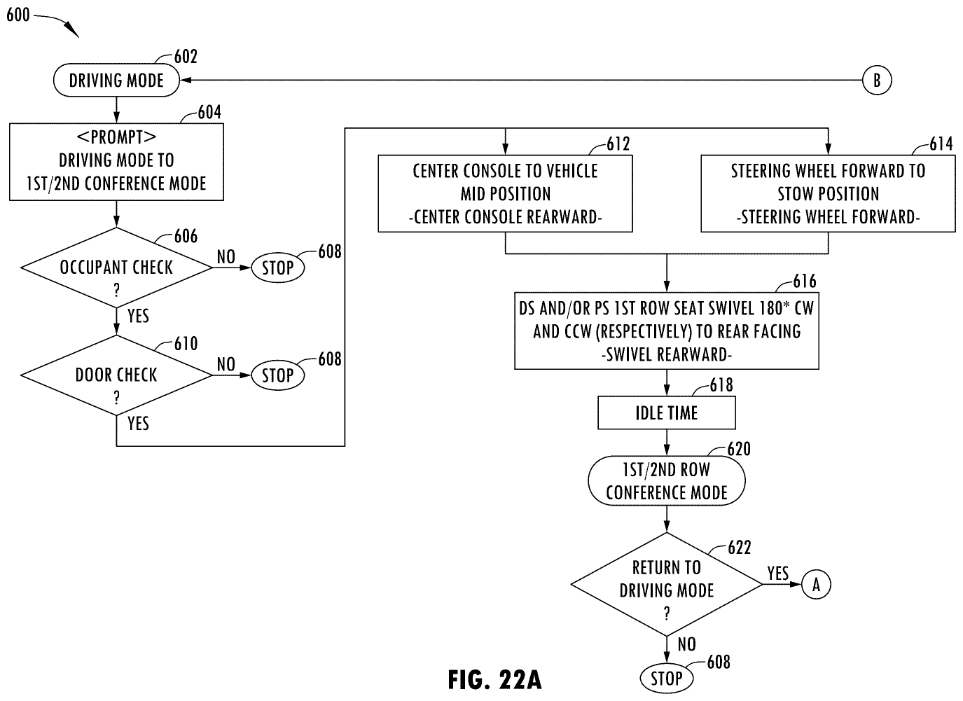

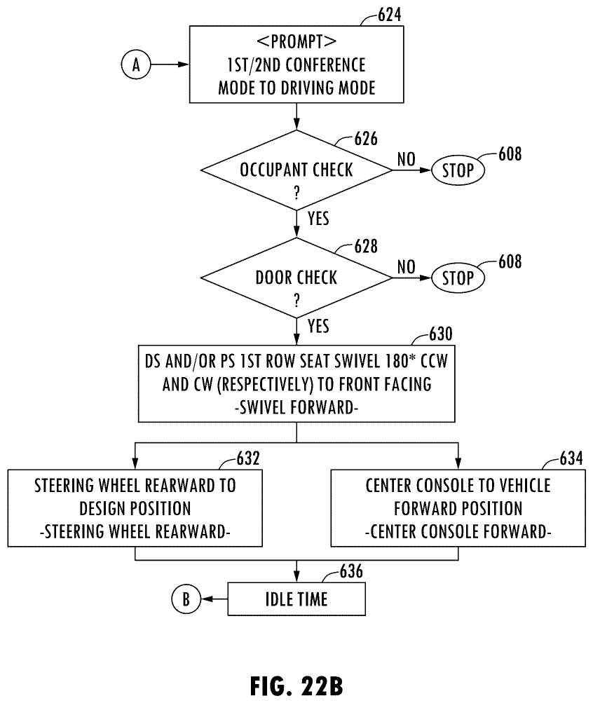

Referring to FIGS. 22A-22B, the control routine 600 is illustrated for transitioning the vehicle passenger compartment between the driving mode and a first row/second row conference mode, according to one example. Routine 600 begins at step 602 in the driving mode and proceeds to step 604 to receive a user input prompt to transition from the driving mode to the conference mode. Routine 600 then proceeds decision step 606 to perform an occupant check to detect occupants in the vehicle. If the occupant check does not pass, indicative of one or more occupants seated in the vehicle, routine 600 will stop at step 608. If no occupants are detected in the vehicle, routine 600 proceeds to perform a door check at decision step 610 to detect any open doors on the vehicle. If the door open check does not pass indicative of a door open on the vehicle, routine 600 stops at step 608. Otherwise, if no doors are detected open, routine 600 proceeds to each of steps 612 and 614.

At step 612, routine 600 will command the center console to move from a mid position to a vehicle rearward position. At step 614, routine 600 will command the steering wheel to move vehicle forward to the stowed position. Once the center console and steering wheel have been moved to the corresponding positions, routine 600 proceeds to step 616 to command the driver's side and/or passenger side first row seats to swivel 180 degrees clockwise and counterclockwise, respectively, to rear facing positions. Thereafter, routine 600 will pause for an idle time at step 618. Next, routine 600 proceeds to confirm that the seating arrangement is configured in the first/second seating row conference mode at step 620.

Routine 600 will then proceed to decision step 622 to determine if the passenger compartment arrangement is to transition back to the driving mode and, if not, stops at step 608. If the vehicle is commanded to return to the driving mode, routine 600 proceeds to step 624 to receive a user prompt to transition from the first/second conference mode to the driving mode. Next, at decision step 626, routine 600 performs an occupant check. If routine 600 does not pass the occupant check, indicative of an occupant seated in the vehicle, routine 600 stops at step 608. If there are no occupants detected in the vehicle, routine 600 proceeds to decision step 628 to perform a door check. If the door check does not pass, indicative of an open door, routine 600 proceeds to step 608. Otherwise, if no doors are open, routine 600 proceeds to step 630 to command the driver's side and/or passenger side first row seats to swivel 180 degrees counterclockwise and clockwise, respectively, to the front facing positions. Routine 600 then proceeds to each of steps 632 and 634. At step 632, routine 600 commands the steering wheel to be moved vehicle rearward to the driving position. At step 634, routine 600 commands the center console to move to the vehicle forward position. Thereafter, routine 600 pauses for an idle time at step 636 before returning to step 602 which confirms the vehicle is in the driving mode.

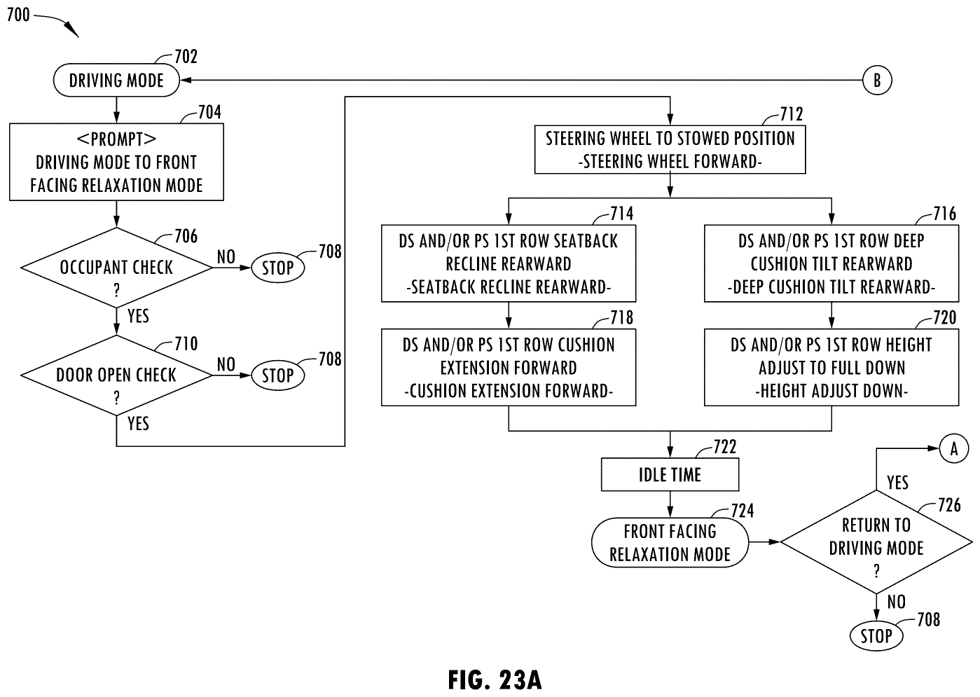

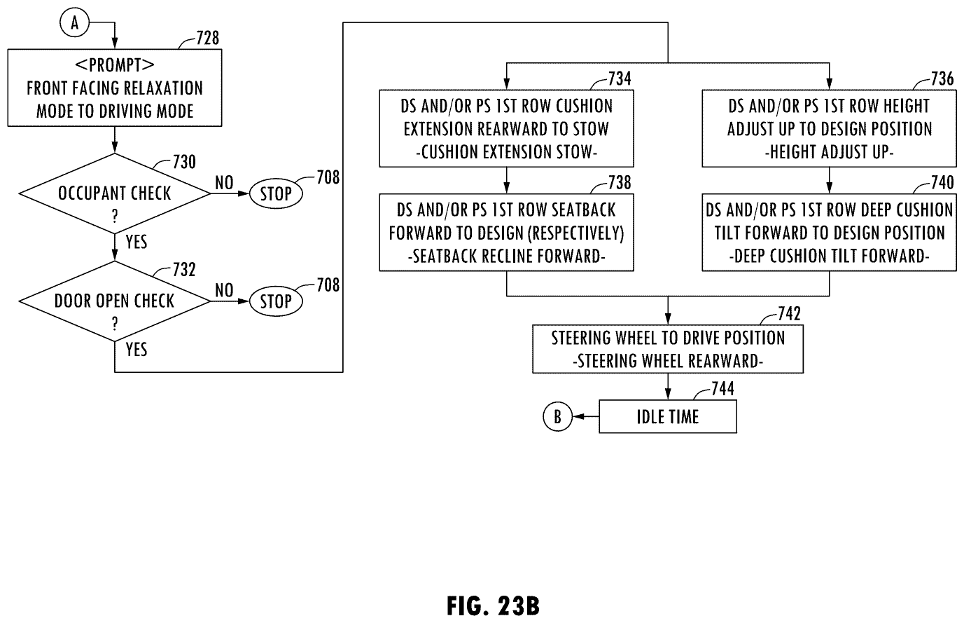

Referring to FIGS. 23A-23B, the control routine 700 is illustrated for transitioning the vehicle passenger compartment from the driving mode to the front facing relaxation mode, according to one example. Routine 700 begins at step 702 in the driving mode and proceeds to step 704 to receive a user input prompt to transition from the driving mode to the front facing relaxation mode. Routine 700 then proceeds to decision step 706 to perform an occupant detection check. If the occupant detection check does not pass, indicative of an occupant seated in the vehicle, routine 700 proceeds to stop at step 708. If there are no occupants seated in the vehicle, routine 700 proceeds to decision step 710 to perform a door open check. If the door open check does not pass, indicative of one or more doors being open, routine 700 stops at step 708. If there are no vehicle doors open, routine 700 proceeds to step 712 to command the steering wheel to move to the stowed position which may be generally forward of the driving position.

Once the steering wheel has moved to the stowed position, routine 700 proceeds to each of steps 714 and 716. At step 714, routine 700 commands the driver's side and/or passenger side first row seat backs to recline rearward, and then further commands the driver's side and/or passenger side first row seat cushions to extend forward in step 718. At step 716, routine 700 commands the driver's side and/or the passenger side first row seat cushions to tilt rearward and further commands the driver's side and/or passenger side first row height adjustment to the fold down position in step 720. Thereafter, routine 700 pauses for an idle time 722 before confirming that the passenger compartment of the vehicle is configured in the front facing relaxation mode.

While in the front facing relaxation mode, routine 700 may further determine at decision step 726 if the cabin arrangement is to return to the driving mode and, if not, stops at step 708. If the cabin arrangement is determined to return to the driving mode, routine 700 proceeds to step 728 to receive a user input commanding the front facing relaxation mode transition to the driving mode. Once this transition is requested, routine 700 proceeds to decision step 730 to perform an occupant check. If the occupant check does not pass, indicative of one or more occupants seated in the vehicle, routine 700 stops at step 708. If there are no occupants seated in the vehicle, routine 700 proceeds to decision step 732 to perform the door open check. If the door open check does not pass, indicative of one or more doors open in the vehicle, routine 700 stops at step 708. If there are no doors open in the vehicle, routine 700 proceeds to steps 734 and 736. At step 734, routine 700 commands the driver's side and/or passenger side first row cushion seat extension to move to a stowed position and further commands the driver's side and/or passenger side first row seat back to move forward to the driving position at step 738. At step 736, routine 700 commands the driver's side and/or passenger side first row height adjustment to move to the driving position and further commands the driver's side and/or passenger side first row seat cushion to tilt forward to the driving position at step 740. Thereafter, routine 700 proceeds to step 742 to command the steering wheel to move to the driving position which is generally vehicle rearward of the stowed position. Routine 700 then pauses for an idle time at step 744 before returning to step 702 to confirm that the vehicle seating configuration is in the driving mode.

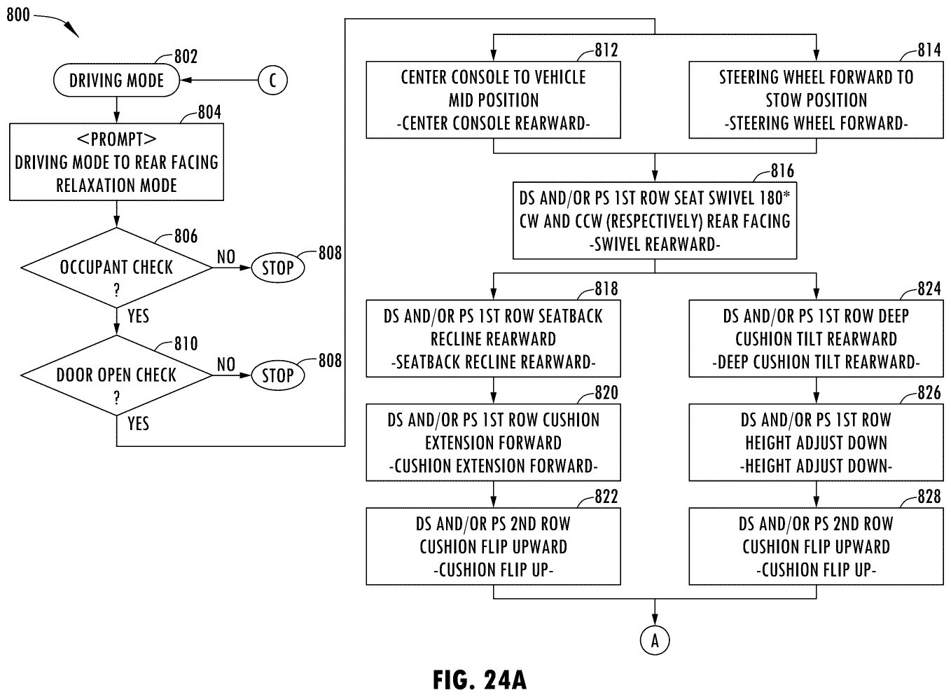

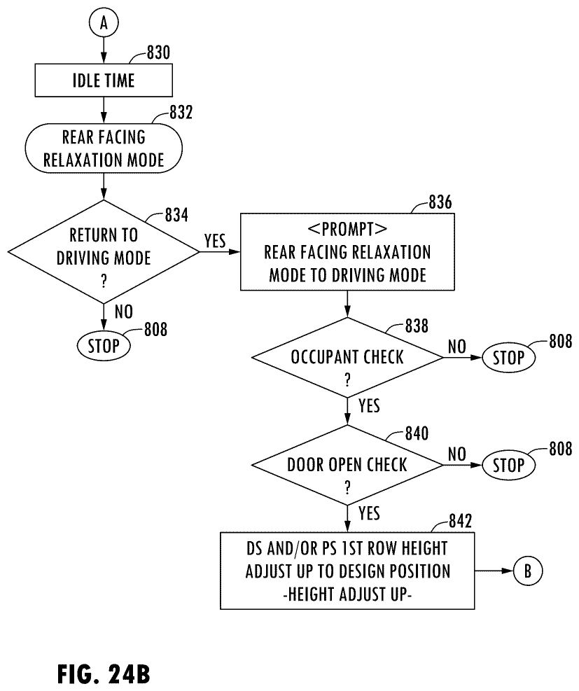

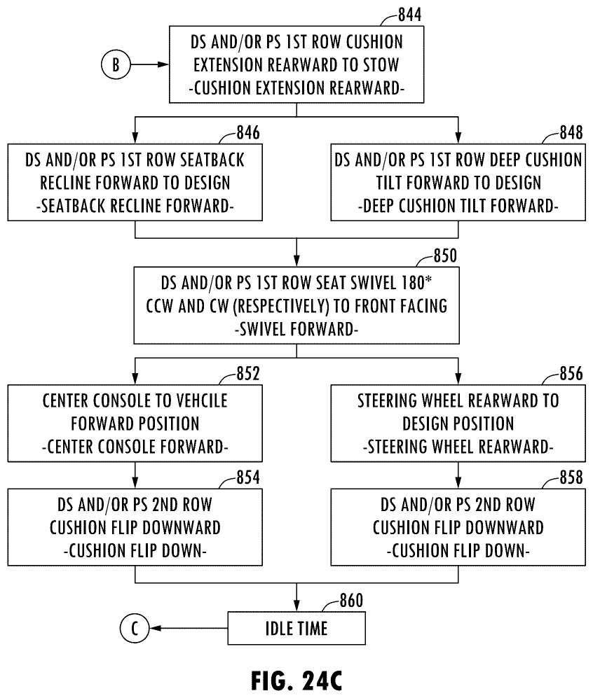

Referring to FIGS. 24A-24C, routine 800 is illustrated for transitioning the vehicle passenger compartment between the driving mode and the rear facing relaxation mode, according to one example. Routine 800 begins at step 802 in the driving mode and proceeds to step 804 to receive a user input prompt to transition from the driving mode to the rear facing relaxation mode. Routine 800 will then proceed to decision step 806 to perform an occupant detection check and to verify there are no obstructions. If the occupant check does not pass, indicative of an occupant seated in the vehicle, routine 800 stops at step 808. If there are no occupants seated in the vehicle, routine 800 proceeds to decision step 810 to perform a door open check. If a door open check does not pass, indicative of one or more doors open in the vehicle, routine 800 stops at step 808. If there are no doors open in the vehicle, routine 800 proceeds to steps 812 and 814.

At step 812, routine 800 commands the center console to move to the vehicle middle position. At step 814, routine 800 commands the steering wheel to move vehicle forward to the stowed position. Thereafter, routine 800 proceeds to step 816 to command the driver's side and/or passenger side first row seats to swivel 180 degrees counterclockwise and clockwise, respectively, to the rear facing positions. Next, routine 800 proceeds to each of steps 818 and 824. At step 818, routine 800 commands the driver's side and/or passenger side first row seat backs to recline rearward. Routine 800 also commands the driver's side and/or passenger side first row seat cushion extensions to move forward at step 820. Routine 800 further commands the driver's side and/or passenger drive second row cushion seats to flip upward at step 822. At step 824, routine 800 commands the driver's side and/or passenger side first row seat cushions to tilt vehicle rearward. Routine 800 also commands the driver's side and/or passenger side first row height adjustments to move down at step 826. Routine 800 further commands the driver's side and/or passenger side second row seat cushions to flip upward at step 828. Thereafter, routine 800 proceeds to step 830 to pause for an idle time before confirming that the vehicle passenger compartment is configured in the rear facing relaxation mode at step 832.

While in the rear facing relaxation mode, routine 800 proceeds to decision step 834 to determine if the passenger compartment configuration is to return to the driving mode and, if not, stops at step 808. If the passenger compartment configuration is determined to return to the driving mode, routine 800 proceeds to step 836 to receive a user input prompt requesting the transition from the rear facing relaxation mode to the driving mode. Next, at decision step 838, routine 800 performs an occupant check. If the occupant check does not pass, indicative of one or more occupants seated in the vehicle, routine 800 stops at step 808. If there are no passengers seated in the vehicle, routine 800 proceeds to decision step 840 to perform a door open check. If the door open check does not pass, indicative of one or more open doors on the vehicle, routine 800 stops at step 808. If there are no doors open in the vehicle, routine 800 proceeds to step 842 to command the driver's side and/or passenger side first row height adjustment to move up to the driving position. Next, routine 800 commands the driver's side and/or passenger side first row cushion extension to move rearward to the stowed position at step 844. Next, routine 800 proceeds to each of steps 846 and 848. At step 846, routine 800 commands the driver's side and/or passenger side first row seat back to recline forward to the driving position. At step 848, routine 800 commands the driver's side and/or passenger side first row deep cushion to tilt forward to the driving position. Thereafter, routine 800 proceeds to step 850 to command the driver's side and/or passenger side first row seat to swivel 180 degrees counterclockwise and clockwise, respectively, to face vehicle forward at step 850.

Routine 800 then proceeds to steps 852 and 856. At step 852, routine 800 commands the center console to move the vehicle forward position and further commands the driver's side and/or passenger side second row cushion to flip downward at step 854. At step 856, routine 800 commands the steering wheel to move rearward to the driving position and further commands the driver's side and/or passenger side second row cushion to flip downward at step 858. Thereafter, routine 800 pauses for an idle time 860 before returning to step 802 to confirm the passenger compartment is in the driving mode.

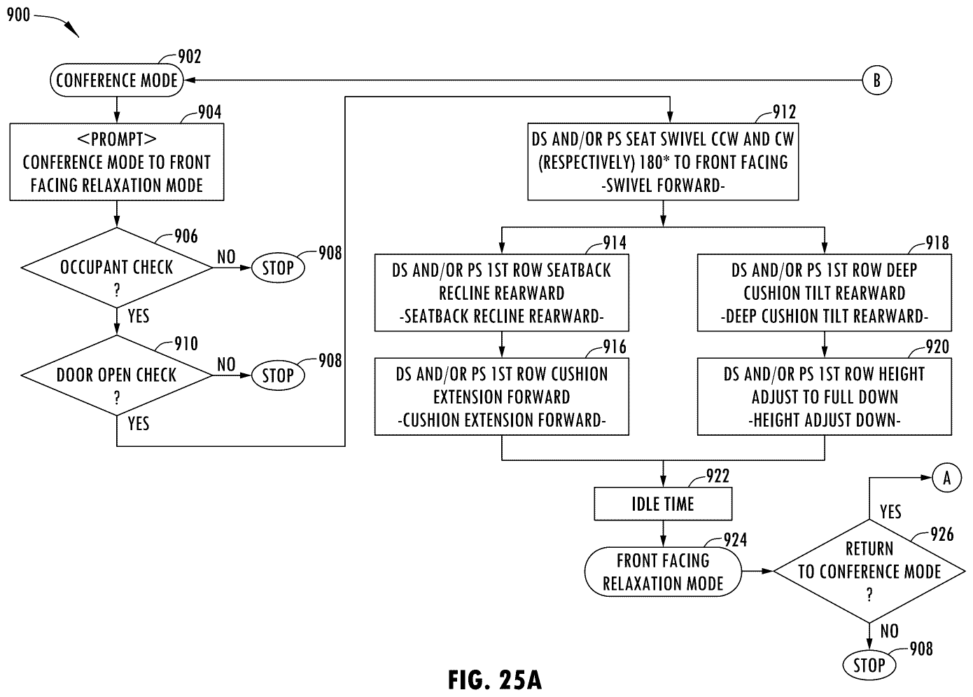

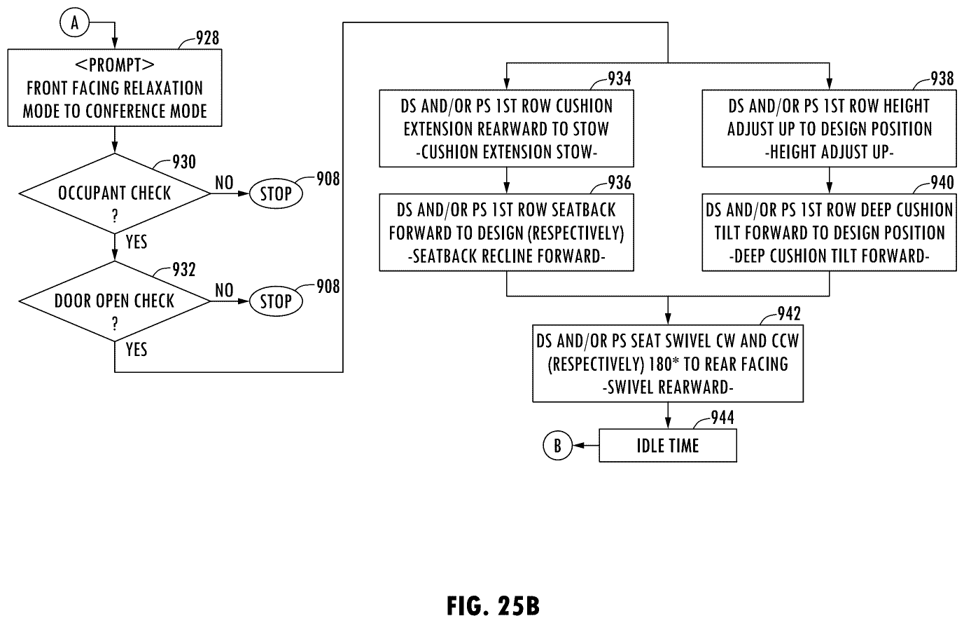

Referring to FIGS. 25A-25B, the control routine 900 is illustrated for transitioning the vehicle passenger compartment between the conference mode and the front facing relaxation mode, according to one example. Routine 900 begins at step 902 in the conference mode and proceeds to step 904 to receive a user input prompt to transition from the conference mode to the front facing relaxation mode. Routine 900 will then proceed to decision step 906 to perform an occupant detection check and to verify there are no obstructions. If the occupant detection check does not pass, indicative of one or more occupants seated in the vehicle, routine 900 will stop at step 908. If there are no occupants seated in the vehicle, routine 900 proceeds to perform a door open check at decision step 910. If the door open check does not pass, indicative of one or more open doors on the vehicle, routine 900 proceeds to stop at step 908.

If there are no doors open on the vehicle, routine 900 proceeds to step 912 to command the driver's side and/or passenger side seats to swivel counterclockwise and clockwise, respectively, 180 degrees to face vehicle forward. Next, routine 900 proceeds to steps 914 and 918. At step 914, routine 900 commands the driver's side and/or passenger side first row seat backs to recline rearward and further commands the driver's side and/or passenger side first row seat cushions extension to move forward at step 916. At step 918, routine 900 commands the driver's side and/or passenger side first row seat cushions to tilt rearward and further commands the driver's side and/or passenger side first row height adjustments to fold down position at step 920. Thereafter, routine 900 pauses for an idle time at step 922 and then proceeds to step 924 to confirm that the vehicle passenger compartment is configured in the front facing relaxation mode.

While in the front facing relaxation mode, routine 900 will determine at decision step 926 if the vehicle is to return to the conference mode and, if not, stops at step 908. If the vehicle is to return to the conference mode, routine 900 proceeds to step 926 to receive a user input prompt to request transitioning from the front facing relaxation mode to the conference mode. Next, at decision step 930, routine 900 performs an occupant detection check. If the occupant detection check does not pass, indicative of one or more occupants seated in the vehicle, routine 900 stops at step 908. If there are no occupants seated in the vehicle, routine 900 proceeds to decision step 932 to perform a door open check. If the door open check does not pass, indicative of one or more open doors on the vehicle, routine 900 stops at step 908. If there are no doors open on the vehicle, routine 900 proceeds to each of steps 934 and 938.

At step 934, routine 900 commands the driver's side and/or passenger side first row cushion extensions to move rearward to the stowed position and further commands the driver's side and/or passenger side first row seat backs to move forward to the driving position at step 936. At step 938, routine 900 commands the driver's side and/or passenger side first row height adjustments up to the driving position and further commands the driver's side and/or passenger side first row seat cushions to tilt forward to the driving position at step 940. Thereafter, routine 900 commands the driver's side and/or passenger side seats to swivel clockwise and counterclockwise, respectively, 180 degrees to the vehicle rear facing positions. Routine 900 then pauses for an idle time at 944 before returning to step 902 to confirm that the vehicle passenger compartment is configured in the conference mode.

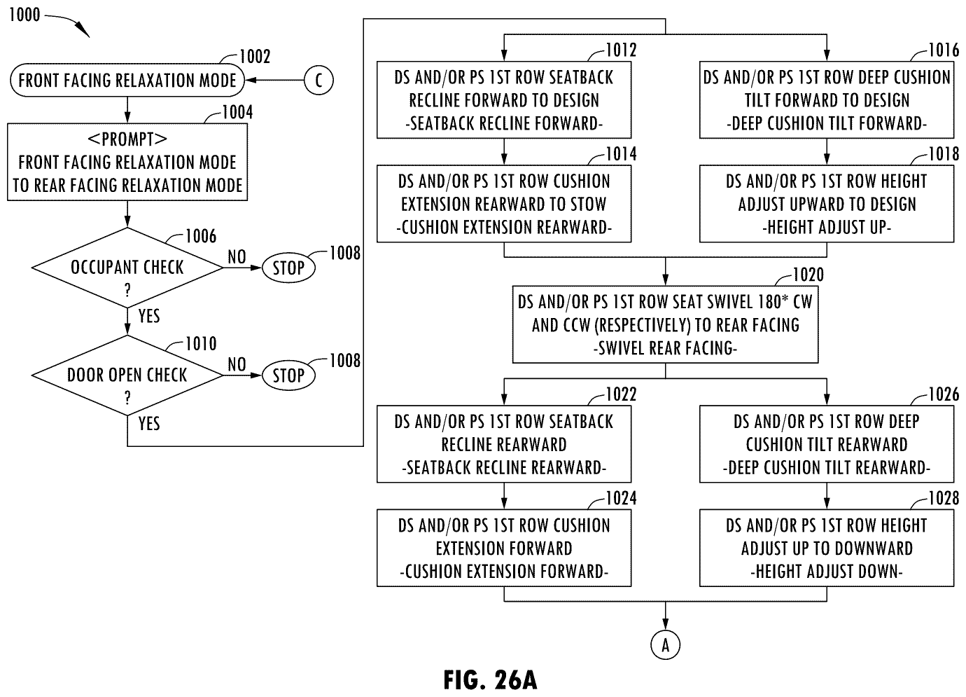

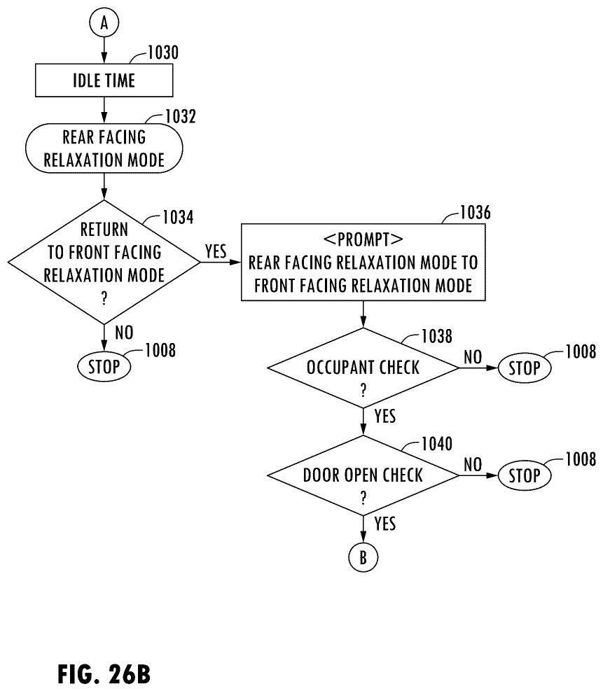

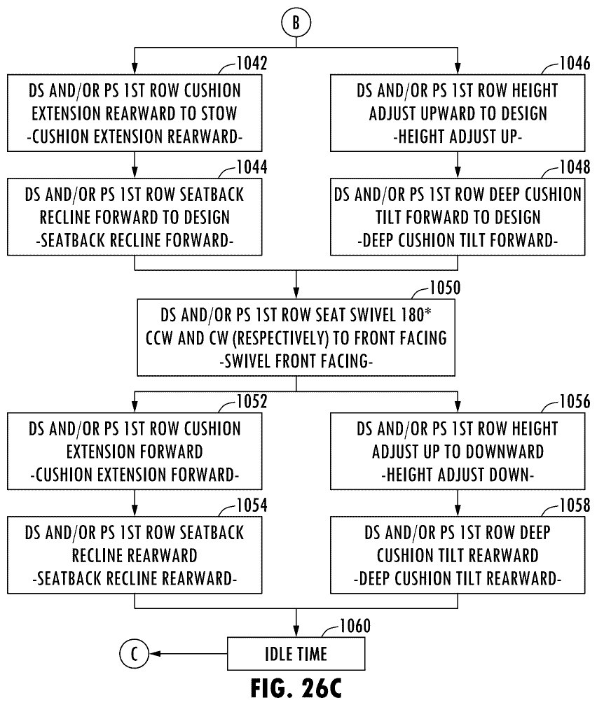

Referring to FIGS. 26A-26C, the control routine 1000 is illustrated for transitioning the vehicle passenger compartment between the front facing relaxation mode and the rear facing relaxation mode, according to one example. Routine 1000 begins at step 1002 in the front facing relaxation mode and proceeds to step 1000 to receive a user input prompt to transition from the front facing relaxation mode to the rear facing relaxation mode. Routine 1000 performs an occupant detection check at decision step 1006. If the occupant detection step does not pass, indicative of one or more occupants seated in the vehicle, routine 1000 stops at step 1008. If there are no occupants seated in the vehicle, routine 1000 proceeds to decision step 1010 to perform a door open check. If the door open check does not pass, indicative of one or more doors open on the vehicle, routine 1000 stops at step 1008. If there are no doors open on the vehicle, routine 1000 proceeds to steps 1012 and 1016.

At step 1012, routine 1000 commands the driver's side and/or passenger side first row seat backs to recline forward to the driving position and further commands the driver's side and/or passenger side first row seat cushion extensions rearward to the stowed position at step 1014. At step 1016, routine 1000 commands the driver's side and/or passenger side first row seat cushions to tilt forward to the driving position and further commands the driver's side and/or passenger side first row height adjustments upwards to the driving position at step 1018. Thereafter, routine 1000 proceeds to step 1020 to command the driver's side and/or passenger side first row seat to swivel 180 degrees clockwise and counterclockwise, respectively, to the rear facing positions. Next, routine 1000 proceeds to steps 1022 and 1026. At step 1022, routine 1000 commands the driver's side and/or passenger side first row seat backs to recline rearward and further commands the driver's side and/or passenger side first row cushion extensions to the forward position at step 1024. At step 1026, routine 1000 commands the driver's side and/or passenger side first row seat cushions to tilt rearward and further commands the driver's side and/or passenger side first row height adjustments to adjust downward at step 1028. Routine 1000 then pauses for an idle time at step 1030 before proceeding to step 1032 to confirm that the vehicle passenger compartment is configured in the rear facing relaxation mode.

With the passenger compartment of the vehicle configured in the rear facing relaxation mode, routine 1000 proceeds to decision step 1034 to determine if the vehicle is to return to the front facing relaxation mode and, if not, stops at step 1008. If it is determined that the vehicle is to return to the front facing relaxation mode, routine 1000 proceeds to step 1036 to receive a user input prompt prompting the vehicle to transition from the rear facing relaxation mode to the front facing relaxation mode. Next, routine 1000 proceeds to decision step 1038 to perform an occupant detection check. If the occupant detection check does not pass, indicative of one or more occupants seated in the vehicle, routine 1000 stops at step 1008. If there are no occupants seated in the vehicle, routine 1000 proceeds to perform a door open check at decision step 1040. If the door open check does not pass, indicative of one or more open doors in the vehicle, routine 1000 stops at step 1008. If there are no doors open on the vehicle, routine 1000 proceeds to steps 1042 and 1046.

At step 1042, routine 1000 commands the driver's side and/or passenger side first row cushion extensions to move rearward to the stowed position and further commands the driver's side and/or passenger side first row seat backs to recline forward to the driving position at step 1044. At step 1046, routine 1000 commands the driver's side and/or passenger side first row height adjustments upward to the driving position and further commands the driver's side and/or passenger side first row seat cushions to tilt forward to the driving position at step 1048. Next, routine 1000 commands the driver's side and/or passenger side first row seats to swivel 180 degrees counterclockwise and clockwise, respectively, to front facing positions at step 1050 before proceeding to steps 1052 and 1056. At step 1052, routine 1000 commands the driver's side and/or passenger side first row seat cushion extensions to the forward position and further commands the driver's side and/or passenger side first row seat backs to recline rearward at step 1054. At step 1056, routine 1000 commands the driver's side and/or passenger side first row height adjustments downward and further commands the driver's side and/or passenger side first row seat cushions to tilt rearward at step 1058. Thereafter, routine 1000 pauses for an idle time at step 1060 before returning to step 1002 to confirm the vehicle passenger compartment is configured in the front facing relaxation mode.

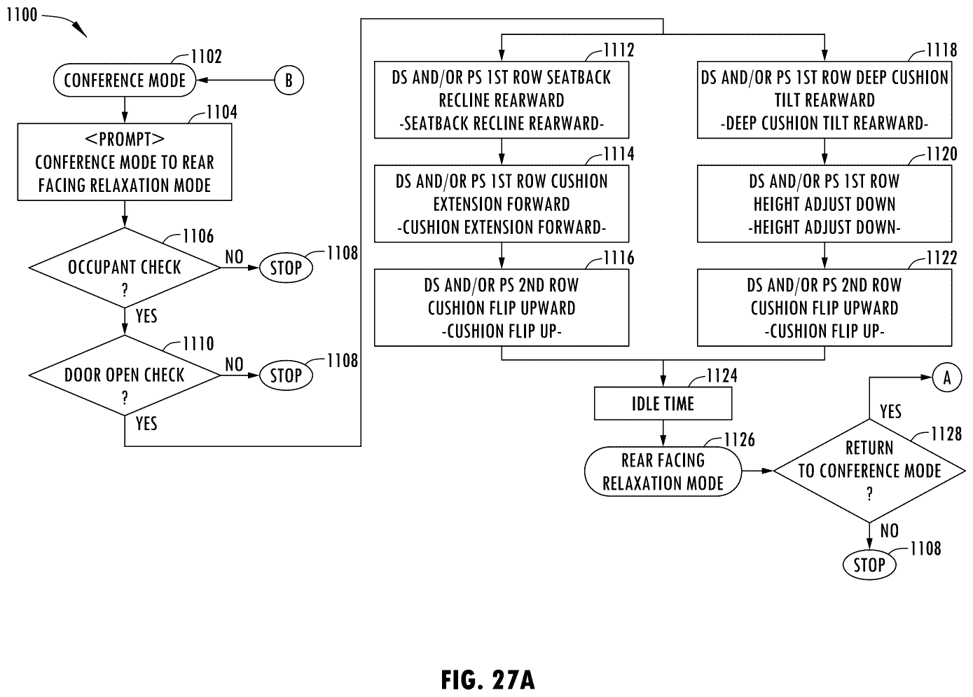

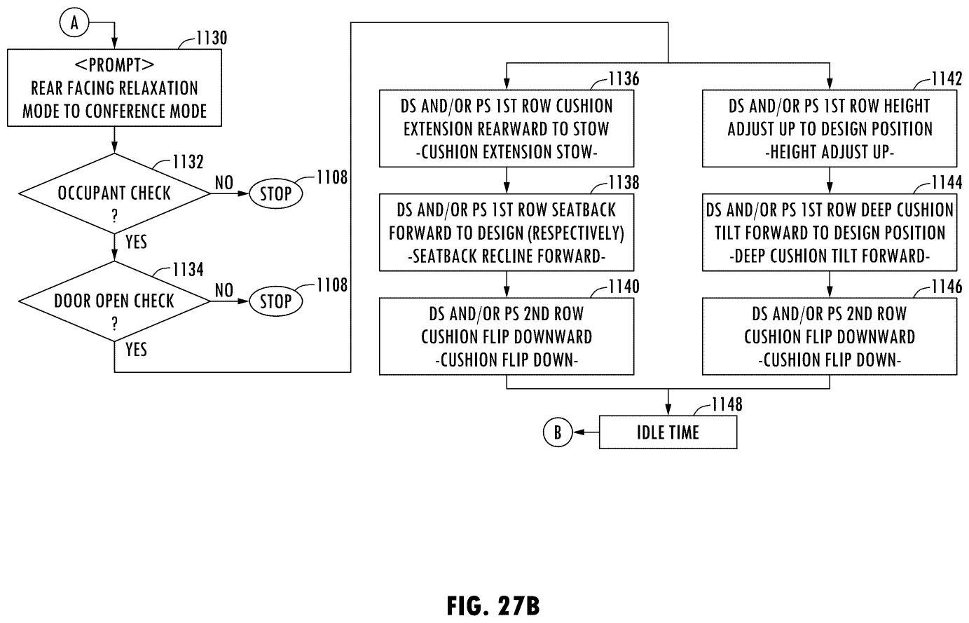

Referring to FIGS. 27A-27B, the control routine 1100 is illustrated for transitioning the vehicle passenger compartment between the conference mode and the rear facing relaxation mode, according to one example. Routine 1100 begins at step 1102 in the conference mode and proceeds to step 1104 to receive a user input prompt to transition from the conference mode to the rear facing relaxation mode. Routine 1100 then proceeds to decision step 1106 to perform an occupant detection check. If the occupant detection check does not pass, indicative of one or more occupants seated in the vehicle, routine 1100 stops at step 1108. If there are no occupants seated in the vehicle, routine 1100 proceeds to perform a door open check at decision step 1110. If the door open check does not pass, indicative of one or more open doors on the vehicle, routine 1100 stops at step 1108. If there are no doors open on the vehicle, routine 1100 proceeds to steps 1112 and 1118.

At step 1112, routine 1100 commands the driver's side and/or passenger side first row seat backs to recline rearward and further commands the driver's side and/or passenger side first row seat cushion extensions to move forward at step 1114 and further commands the driver's side and/or passenger side second row seat cushions to flip upwards at step 1116. At step 1118, routine 1100 commands the driver's side and/or passenger side first row seat cushions to tilt rearward, and also commands the driver's side and/or passenger side first row height adjustments to fold downward to the downward position at step 1120 and further commands the driver's side and/or passenger side second row seat cushions to flip upward at step 1122. Thereafter, routine 1100 pauses for an idle time at step 1124 before proceeding to step 1126 to confirm that the vehicle passenger compartment is configured in the rear facing relaxation mode.

While the vehicle is in the rear facing relaxation mode, routine 1100 proceeds to decision step 1128 to determine if the vehicle is to return to the conference mode and, if not, stops at step 1108. If the vehicle is determined to return to the conference mode, routine 1100 proceeds to step 1130 to receive a user input prompt requesting transition from the rear facing relaxation mode to the conference mode. Next, an occupant detection check is performed at decision step 1132. If the occupant detection check does not pass, indicative of one or more occupants seated in the vehicle, routine 1100 stops at step 1108. If there are no occupants seated in the vehicle, routine 1100 proceeds to perform a door open check at decision step 1134. If the door open check does not pass, indicative of one or more doors open on the vehicle, routine 1100 stops at step 1108. If there are no doors open on the vehicle, routine 1100 proceeds to steps 1136 and 1142.

At step 1136, routine 1100 commands the driver's side and/or passenger side first row seat cushion extensions to move rearward to the stowed position and commands the driver's side and/or passenger side first row seat backs to move forward to the driving position at step 1138 and further commands the driver's side and/or passenger side second row seat cushions to flip downward at step 1140. At step 1142, routine 1100 commands the driver's side and/or passenger side first row height adjustments to adjust up to the driving position and commands the driver's side and/or passenger side first row seat cushions to tilt forward to the driving position at step 1144 and further commands the driver's side and/or passenger side second row cushions to flip downward at step 1146. Thereafter, routine 1100 pauses for an idle time at step 1148 before returning to step 1102 to confirm that the vehicle passenger compartment is configured in the conference mode.

The motor vehicle 10, as illustrated in the embodiment shown in FIG. 16, is configured to move the seating arrangement, the center console and the steering wheel amongst a plurality of positions to accommodate the transition between a plurality of passenger compartment configurations. While transitions between various modes including the driving mode 362, the front facing relaxation mode 580, the rear facing relaxation mode 582, and the rear facing conference mode 584 are shown and described herein, it should be appreciated that the vehicle passenger compartment may transition between these and other modes.

Accordingly, a motor vehicle 10 in the form of a three-row seating pickup truck is provided having six doors and a convertible passenger compartment 14 with a seating and center console arrangement that may be configured to transition to any of a plurality of passenger compartment arrangements. A user may simply initiate the transition to a passenger compartment mode on an input device, such as on a phone, a key fob, a touchscreen display, an audio input, or other inputs, to change the seating and center console configurations to accommodate a selected passenger compartment arrangement.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A motor vehicle comprising:
a passenger compartment;
a steering wheel configured to be moveable between a use position and a stowed position;
a floor;
a seating rail system positioned on the floor and extending along a longitudinal direction of the motor vehicle;
a plurality of seating assemblies arranged in the passenger compartment in a first row and a second row located rearward of the first row, each of the seating assemblies comprising:
a seat base coupled to the seating rail system;
a seat movably coupled to the seat base;
a seat back movably coupled to the seat base; and
one or more seat actuators configured to actuate the seating assemblies to a plurality of positions; and
a controller configured to receive an input commanding a selected passenger compartment arrangement, wherein the controller controls the actuators to position the seat assemblies and the steering wheel in the commanded passenger compartment arrangement.

2. The vehicle of claim 1, further comprising:
a center console rail system;
a center console positioned on the center console rail system extending longitudinally on the floor; and
a center console actuator to actuate the center console on the center console rail system, wherein the controller controls the actuators to position the center console in the commanded passenger compartment arrangement.

3. The vehicle of claim 1, further comprising a user input device for inputting selection of the user input.

4. The vehicle of claim 2, wherein the user input device comprises one of a phone, a key fob, a microphone, a gesture detecting device, and a touchscreen display.

5. The vehicle of claim 1, wherein the selected seating arrangement includes one of a driving mode, a conference mode, and a relaxation mode.

6. The vehicle of claim 5, wherein the relaxation mode comprises one of a front facing rear relaxation mode and a rear facing relaxation mode.

7. The vehicle of claim 1, wherein the seating assemblies in the first row seating and the second row seating further comprise a swivel actuator for rotating the seats about a vertical axis.

8. The vehicle of claim 1, wherein the plurality of seating assemblies further comprises a third row located rearward of the second row.

9. The vehicle of claim 8, wherein the third row seating comprises a seat back adjacent to a rear wall of the passenger compartment.

10. The vehicle of claim 9, wherein the forward region includes the first row, the central region includes the second row, and the rearward region includes the third row in a driving mode.

11. The vehicle of claim 10, wherein the vehicle comprises a pickup truck.

12. The vehicle of claim 11, wherein the pickup truck comprises three doors on each of the opposite lateral sides for accessing the three rows of seating.

13. A motor vehicle configured as a pickup truck, the motor vehicle comprising:
a passenger compartment having a forward region, a central region, and a rearward region;
a steering wheel configured to be moveable between a use position and a stowed position;
a floor;
a seating rail system positioned on the floor and extending along a longitudinal direction of the motor vehicle;
and a plurality of seating assemblies arranged in the passenger compartment in a first row configurable in the forward region, a second row configurable in the middle region and located rearward of the first row, and a third row configurable in the rearward region located rearward of the second row, each of the seating assemblies comprising:
a seat base coupled to the seating rail system;
a seat movably coupled to the seat base;
a seat back movably coupled to the seat base; and
one or more seat actuators configured to actuate the seating assemblies to a plurality of positions;
a center console rail system;
a center console positioned on the center console rail system extending longitudinally on the floor;
a center console actuator to actuate the center console on the center console rail system; and
a controller configured to receive an input commanding a selected passenger compartment arrangement, wherein the controller controls the actuators to position the seat assemblies, the center console and the steering wheel in the commanded passenger compartment arrangement.

14. The vehicle of claim 13, further comprising a user input device for inputting selection of the user input.

15. The vehicle of claim 14, wherein the user input device comprises one of a phone, a key fob, a microphone, a gesture detecting device, and a touchscreen display.

16. The vehicle of claim 13, wherein the selected seating arrangement includes one of a driving mode, a conference mode and a relaxation mode.

17. The vehicle of claim 16, wherein the relaxation mode comprises one of a front facing relaxation mode and a rear facing relaxation mode.

18. The vehicle of claim 13, wherein the seating assemblies in the first row seating and the second row seating further comprise a swivel actuator for rotating the seats about a vertical axis.

19. The vehicle of claim 13, wherein the third row seating comprises a seat back adjacent to a rear wall of the cab.

20. The vehicle of claim 13, wherein the pickup truck comprises three doors on each of opposite lateral sides for accessing the three rows of seating.
